(19) United States
(12) Patent Application Publication
(10) Pub. No.: US 2025/0276525 A1
(43) Pub. Date: Sep. 4, 2025

(54) LIQUID EJECTING APPARATUS, CONTROL METHOD OF LIQUID EJECTING APPARATUS AND MEDIUM STORING CONTROL PROGRAM FOR LIQUID EJECTING APPARATUS

(71) Applicant: BROTHER KOGYO KABUSHIKI KAISHA, Nagoya (JP)

(72) Inventors: MOTOKI YAMADA, Nagoya (JP); HIROYA OKUWA, Tajimi (JP); RUI WANG, Nagoya (JP); MIKIO HIRANO, Okazaki (JP)

(21) Appl. No.: 19/058,281

(22) Filed: Feb. 20, 2025

(30) Foreign Application Priority Data
Feb. 29, 2024 (JP) 2024-029877

(51) Int. Cl. B41J 2/165; C09D 11/30

(52) U.S. Cl. CPC B41J 2/16505; C09D 11/30; B41J 2002/16594; B41P 2235/27

(57) ABSTRACT

A liquid ejecting apparatus includes: a liquid ejecting head having an ejection surface; a cap for covering the ejection surface; a suction pump; a cleaning liquid tank; and a switching valve having a fixed member, a rotation member, and a channel member. The fixed member has: a main body supporting the channel member; a cleaning liquid upstream port connected to the cleaning liquid tank; a cleaning liquid downstream port and a waste liquid port each connected to the cap; and an intake port connected to a tube in which the suction pump is disposed. The rotation member rotates with respect to the fixed member, and has a first cleaning liquid path. The channel member is attached to the rotation member and configured to rotate together with the rotation member with respect to the fixed member, and has: a second cleaning liquid path; and a waste liquid path.

### REFERENCE TO RELATED APPLICATIONS

This application claims priority from Japanese Patent Application No. 2024-029877 filed on Feb. 29, 2024. The entire content of the priority application is incorporated herein by reference.

### BACKGROUND ART

Conventionally, a liquid ejecting apparatus including a liquid ejecting head and a maintenance unit is known. The liquid ejecting head has a nozzle which ejects ink, and an ejection surface in which the nozzle is open. The maintenance unit has a cap which covers the ejection surface, a suction pump which performs suction inside the cap, a waste liquid tank, and a switching valve.

### SUMMARY

In the above-described liquid ejecting apparatus, the switching valve performs switching between communication and shutting-off among the cap, the suction pump, and the waste liquid tank, thereby performing a suction purge in which the suction pump performs the suction inside the cap covering the ejection surface. Since the ink is discharged from the nozzle by the suction purge, the ink might adhere, in some cases, to the ejection surface in which the nozzle is open. In a case where ink having a satisfactory fixing property is used and where the ink adheres to the ejection surface and dries, the ink which has adhered and dried might cause unsatisfactory ejection of the ink from the nozzle.

In view of the above-described situation, the present disclosure aims to provide a liquid ejecting apparatus, a control method of the liquid ejecting apparatus, and a medium storing a control program for the liquid ejecting apparatus each of which is capable of reducing the unsatisfactory ejection of the liquid from the nozzle caused by an adhered substance in the ejection surface.

A liquid ejecting apparatus according to the present disclosure includes: a liquid ejecting head having an ejection surface with nozzles opening therein; a cap configured to cover the ejection surface; a suction pump; a cleaning liquid tank configured to store cleaning liquid; and a switching valve having a fixed member, a rotation member, and a channel member. The fixed member has: a main body configured to support the channel member; a cleaning liquid upstream port being a hollow protrusion protruding from the main body and communicating with the cleaning liquid tank via a tube; a cleaning liquid downstream port and a waste liquid port each being a hollow protrusion protruding from the main body and communicating with the cap via a tube; and an intake port being a hollow protrusion shape protruding from the main body and communicating with a tube having the suction pump disposed therein. The rotation member is configured to rotate with respect to the fixed member, and has a first cleaning liquid path. The channel member is attached to the rotation member and configured to rotate together with the rotation member with respect to the fixed member. The channel member has: a second cleaning liquid path connected to the first cleaning liquid path to form a cleaning liquid path communicating the cleaning liquid upstream port and the cleaning liquid downstream port with each other; and a waste liquid path communicating the waste liquid port and the intake port with each other.

A control method according to the present disclosure is a control method of a liquid ejecting apparatus including: a liquid ejecting head having an ejection surface with nozzles opening therein; a cap configured to cover the ejection surface; a suction pump; a cleaning liquid tank configured to store cleaning liquid; and a switching valve having a fixed member, a rotation member, and a channel member. The fixed member has: a main body configured to support the channel member; and ports including a cleaning liquid upstream port being a hollow protrusion protruding from the main body and communicating with the cleaning liquid tank via a tube, a cleaning liquid downstream port and a waste liquid port each being a hollow protrusion protruding from the main body and communicating with the cap via a tube, and an intake port being a hollow protrusion protruding from the main body and communicating with a tube having the suction pump disposed therein. The rotation member is configured to rotate with respect to the fixed member, and has a first cleaning liquid path. The channel member is attached to the rotation member and is configured to rotate together with the rotation member with respect to the fixed member. The channel member has: a second cleaning liquid path connected to the first cleaning liquid path to form a cleaning liquid path communicating the cleaning liquid upstream port and the cleaning liquid downstream port with each other; and a waste liquid path communicating the waste liquid port and the intake port with each other. The control method includes changing a communication state between the ports and the cleaning liquid path and between the ports and the waste liquid path by rotation of the rotation member.

A non-transitory medium according to the present disclosure is a non-transitory medium storing a control program for a liquid ejecting apparatus. The liquid ejecting apparatus includes: a liquid ejecting head having an ejection surface with nozzles opening therein; a cap configured to cover the ejection surface; a suction pump; a cleaning liquid tank configured to store cleaning liquid; a switching valve having a fixed member, a rotation member, and a channel member; and a controller. The fixed member has: a main body configured to support the channel member; and ports including: a cleaning liquid upstream port being a hollow protrusion protruding from the main body and communicating with the cleaning liquid tank via a tube; a cleaning liquid downstream port and a waste liquid port each being a hollow protrusion protruding from the main body and communicating with the cap via a tube; and an intake port being a hollow protrusion protruding from the main body and communicating with a tube having the suction pump disposed therein. The rotation member is configured to rotate with respect to the fixed member, and has a first cleaning liquid path, and the channel member is attached to the rotation member and is configured to rotate together with the rotation member with respect to the fixed member. The channel member has: a second cleaning liquid path connected to the first cleaning liquid path to form a cleaning liquid path communicating the cleaning liquid upstream port and the cleaning liquid downstream port with each other; and a waste liquid path communicating the waste liquid port and the intake port. The control program causes the controller to change a communication state between the ports and the cleaning liquid path and between the ports and the waste liquid path by rotation of the rotation member.

According to the present disclosure, the rotation member and the channel member are rotated with respect to the fixed member. As a result, the cleaning liquid path communicates with the cleaning liquid upstream port and the cleaning liquid downstream port, and the waste liquid path communicates with the waste liquid port and the intake port. In a case where the suction pump is driven in this state, the suction is performed inside the cap via the intake port, the waste liquid path, and the waste liquid port. Further, the cleaning liquid is sucked from the cleaning liquid tank via the cleaning liquid downstream port, the cleaning liquid path, and the cleaning liquid upstream port which communicate with the cap, and the cleaning liquid flows into the cap. The ejection surface covered by the cap is cleaned by the cleaning liquid, thereby removing the liquid adhered to the ejection surface. Therefore, the unsatisfactory ejection, of the liquid from the nozzle, which is caused due to the adhered substance in the ejection surface can be reduced.

### BRIEF DESCRIPTION OF DRAWINGS

FIG. 1 is a schematic view of a liquid ejecting apparatus according to an embodiment of the present disclosure, as seen from above.

FIG. 2 is a block diagram depicting the configuration of the liquid ejecting apparatus.

FIG. 3 is a schematic view depicting a maintenance unit.

FIG. 4 is a perspective view depicting a switching valve in a partially cut state.

FIG. 5A is a schematic view depicting a switching valve in which a cleaning liquid path communicates a first cleaning liquid upstream port and a first cleaning liquid downstream port with each other, and FIG. 5B is a schematic view depicting the switching valve in which a waste liquid path communicates a first waste liquid port and an intake port with each other.

FIG. 6 is a cross-sectional view depicting the switching valve in which a rotation member is located at a standby position.

FIG. 7A is a cross-sectional view depicting the switching valve in which the rotation member is located at a first purge position, and FIG. 7B is a cross-sectional view depicting the switching valve in which the rotation member is located at a first cleaning position.

FIG. 8A is a cross-sectional view depicting the switching valve in which the rotation member is located at a first pressure-boosting position, and FIG. 8B is a cross-sectional view depicting the switching valve in which the rotation member is located at a first idle suction position.

FIG. 9A is a cross-sectional view depicting the switching valve in which the rotation member is located at a second purge position, and FIG. 9B is a cross-sectional view depicting the switching valve in which the rotation member is located at a second cleaning position.

FIG. 10A is a cross-sectional view depicting the switching valve in which the rotation member is located at a second pressure-boosting position, and FIG. 10B is a cross-sectional view depicting the switching valve in which the rotation member is located at a second idle suction position.

FIG. 11A is a cross-sectional view depicting the switching valve in which the rotation member is located at an exhaust-purge position, and FIG. 11B is a cross-sectional view depicting the switching valve in which the rotation member is located at an exhaust-idle suction position.

FIG. 12 is a flow chart indicating an example of a maintenance process in the liquid ejecting apparatus.

FIG. 13 is a flow chart indicating an example of a maintenance process in a liquid ejecting apparatus according to a first modification.

### DESCRIPTION

### (Liquid Ejecting Apparatus)

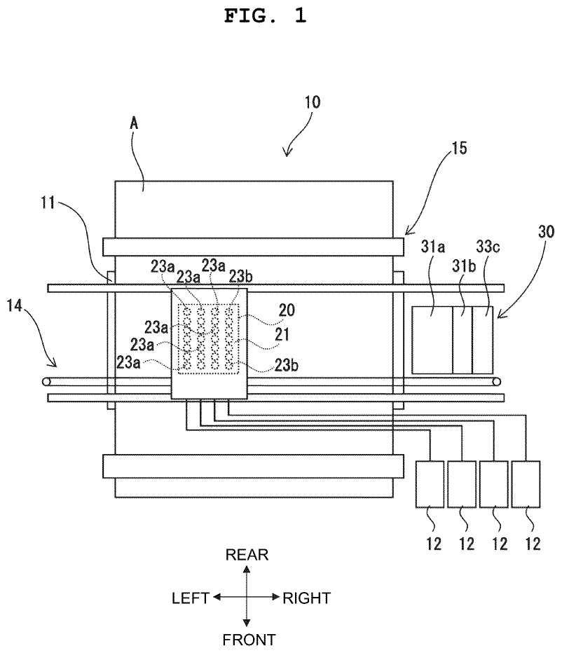

A liquid ejecting apparatus 10 according to an embodiment of the present disclosure is an apparatus configured to eject a liquid, as depicted in FIG. 1. In the following, a case where the liquid ejecting apparatus 10 is used in an inkjet printer which ejects an ink as the liquid will be described, but the liquid ejecting apparatus 10 is not limited to this.

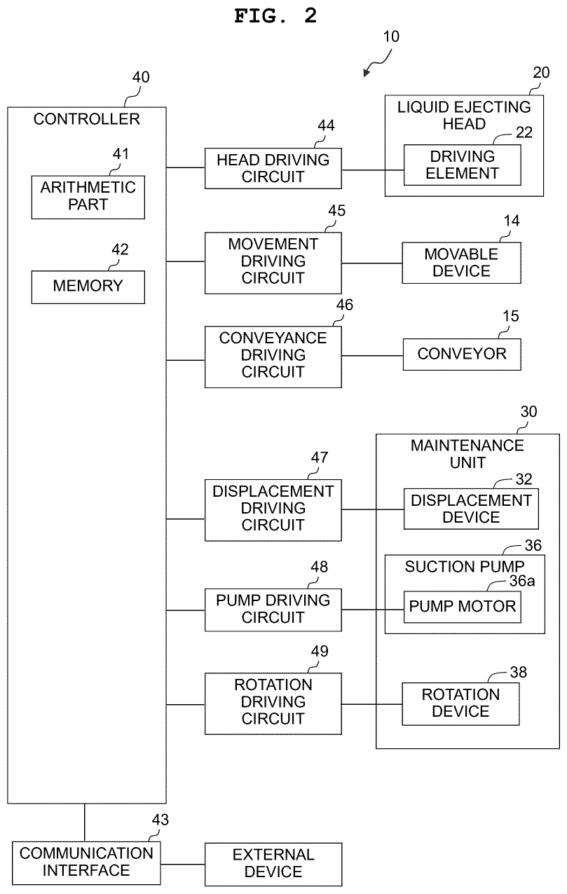

The liquid ejecting apparatus 10 includes a liquid ejecting head 20 which ejects a liquid. The liquid ejecting head 20 includes a channel forming body 21 and a plurality of driving circuits 22 (FIG. 2). A plurality of nozzles is formed in the channel forming body 21, and the plurality of nozzles includes a first nozzle 23a and a second nozzle 23b.

Each of the plurality of driving circuits 22 is a piezoelectric element, a heating element, an electrostatic actuator, etc., and is disposed to correspond to each of the first and second nozzles 23a and 23b, and applies pressure to the liquid in the liquid ejecting head 20 to thereby eject a droplet of the liquid (liquid droplet) from each of the first and second nozzles 23a and 23b. A pressure wave generated as described above acts on the meniscus of the liquid formed in each of the first and second nozzles 23a and 23b, thereby causing the liquid to be ejected from each of the first and second nozzles 23a and 23b. The liquid ejecting head 20 will be described in detail later.

The liquid ejecting apparatus 10 further includes a platen 11. The platen 11 is positioned below the liquid ejecting head 20 at a predetermined distance, and the upper surface of the platen 11 faces the lower surface of the channel forming body 21 of the liquid ejecting head 20 and supports a print medium A from below.

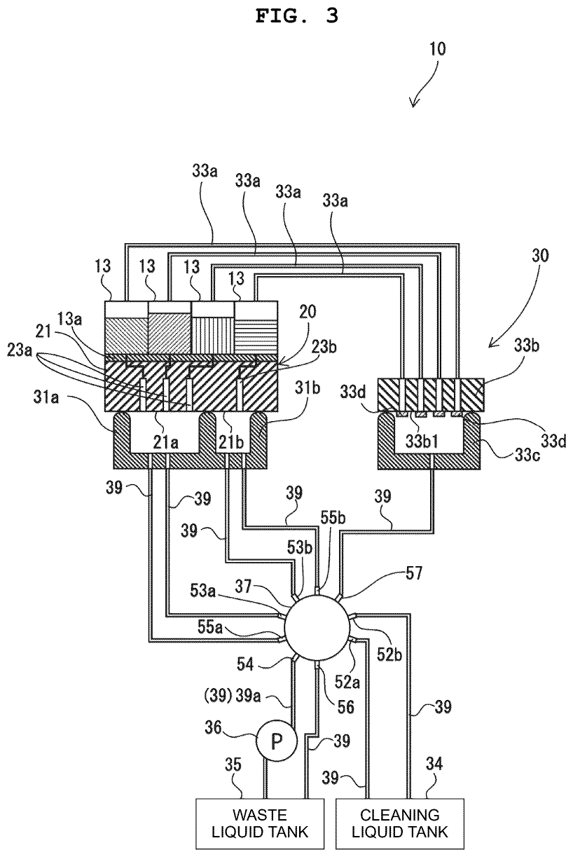

The liquid ejecting apparatus 10 further includes a cartridge 12 and a buffer tank 13 (FIG. 3). The cartridge 12 is detachably installed in a casing of the liquid ejecting apparatus 10, and the cartridge 12 is included in the liquid ejecting apparatus 10 as cartridges 12 of which number is equal to the number of types of liquid ejected from the liquid ejecting head 20 (four in the example of FIG. 1). Each of the cartridges 12 store the liquid and supplies the liquid to a buffer tank 13 disposed on the liquid ejecting head 20. The buffer tank 13 will be described in detail later.

The liquid ejecting apparatus 10 further includes a maintenance unit 30 which performs maintenance of the liquid ejecting head 20. The maintenance unit 30 is disposed, for example, in the left-right direction, in a maintenance range to the right of a print range in which the platen 11 is disposed. The maintenance unit 30 will be described in detail later.

The liquid ejecting apparatus 10 further includes a movable device 14 which is configured to move the liquid ejecting head 20 in the left-right direction, and a conveyor 15 which is configured to convey the print medium A in the front-rear direction. The movable device 14 moves the liquid ejecting head 20 over the print range and the maintenance range. The conveyor 15 conveys the print medium A in the front-rear direction on the platen 11.

As depicted in FIG. 2, the liquid ejecting apparatus 10 further includes a controller 40. The controller 40 is electrically connected to a communication interface 43, and the controller 40 is also electrically connected to the plurality of driving circuits 22 of the liquid ejecting head 20 via a head driving circuit 44, to the movable device 14 via a movement driving circuit 45, to the conveyor 15 via a conveyance driving circuit 46, and to a displacement device 32, a suction pump 36 and a rotation device 38 which are disposed in the maintenance unit 30, via, respectively, a displacement driving circuit 47, a pump driving circuit 48 and a rotation driving circuit 49. The communication interface 43 is capable of communicating with an external device such as a computer, a portable terminal device, etc., and the communication interface 43 is configured to transmit and receive data between the communication interface 43 and the external device.

The controller 40 is constructed, for example, of a computer, and has an arithmetic part 41 and a memory 42. The memory 42 is a memory accessible from the arithmetic part 41, and includes, for example, a RAM, a ROM, etc. The memory 42 stores data input from the communication interface 43, as well as a computer program and various data which are to be used for data processing by the arithmetic part 41. The data includes image data, such as raster data, etc., which represent an object image of a printing process.

The arithmetic part 41 includes, for example, a processor such as a CPU, etc., an integrated circuit such as an ASIC, etc., or both; and the like. The arithmetic part 41 executes a computer program while referring to data stored in the memory 42, and thus the controller 40 controls the operation of the respective parts of the liquid ejecting apparatus 10. With this, the liquid ejecting apparatus 10 executes various processes such as a printing process of printing an image, and a maintenance process of the liquid ejecting head 20, etc. These processes will be described later.

Further, the controller 40 may be constructed of a single device, or the controller 40 may be constructed of a plurality of devices distributed and configured to cooperate with each other to perform the operation of the controller 40. For example, the liquid ejecting apparatus 10 may be constructed as an information processing part of a personal computer, a portable terminal device, etc., and as a liquid ejection executing part having the liquid ejecting head 20. The information processing part and the liquid ejection executing part are constructed as separate bodies capable of communicating with each other. In this case, the controller 40 may be constructed of a controller of the information processing part and a controller of the liquid ejection executing part. These controllers cooperate with each other to perform the operation of the controller 40 of the liquid ejecting apparatus 10.

### (Liquid Ejecting Head)

As depicted in FIG. 1 and FIG. 3, the plurality of nozzles includes a plurality of first nozzles 23a which eject a first liquid, and a plurality of second nozzles 23b which eject a second liquid. For example, the first liquid may be a color ink, such as a cyan ink, a magenta ink, and a yellow ink. The second liquid may be a liquid different from the first liquid, such as a black ink. The first liquid and the second liquid will be described in detail later.

The first and second nozzles 23a and 23b are open in an ejection surface which is the lower surface of the channel forming body 21. The ejection surface includes a first ejection surface 21a in which the plurality of first nozzles 23a are open, and a second ejection surface 21b in which the plurality of second nozzles 23b are open (see FIG. 3). For example, the second ejection surface 21b is disposed to the right of the first ejection surface 21a.

In the first ejection surface 21a, the plurality of first nozzles 23a are aligned in the front-rear direction to form a first nozzle row, and a plurality of first nozzle rows including the first nozzle row are disposed side by side in the left-right direction. The plurality of first nozzle rows includes a row of first nozzles 23a which eject the cyan ink, a row of first nozzles 23a which eject the magenta ink, and a row of first nozzles 23a which eject the yellow ink. In the second ejection surface 21b, the plurality of second nozzles 23b are aligned in the front-rear direction to form a second nozzle row, and the second nozzle row is disposed, for example, to the right of the plurality of first nozzle rows.

### (First Liquid and Second Liquid)

Each of the first liquid and the second liquid is, for example, an ink such as a water-based ink, etc., and contains resin fine particles, a solid content of a colorant, an organic solvent, a surfactant, and water. In this case, the ink has wettability with respect to a hydrophobic recording medium such as a coated paper sheet, plastic, film, an OHP sheet, etc. The ink, however, is not limited to this, and may be an ink suitable for recording an image, for example, on a recording medium other than the hydrophobic recording medium, such as a regular paper sheet, a glossy paper sheet, a matte paper sheet, etc. The term “coated paper sheet” means, for example, high-quality printing paper sheet, medium-quality printing paper sheet, etc., which is plain paper sheet having pulp as a main constituent element thereof and having a coating agent applied thereon for a purpose of improving the smoothness, whiteness, glossiness, etc. Specifically, the coated paper sheet is exemplified by high-quality coated paper sheet, medium-quality coated paper sheet, etc.

As the resin fine particles, for example, resin fine particles including at least one of methacrylic acid and acrylic acid as a monomer can be used. For example, a commercially available product may be used as the resin fine particles. The resin fine particles may further include, as the monomer, styrene, vinyl chloride, etc. The resin fine particles may be, for example, resin fine particles included in an emulsion. The emulsion is composed, for example, of resin fine particles and a dispersion medium (for example, water, etc.). The resin fine particles are dispersed with respect to the dispersion medium with a specific range of a particle diameter, not being in a dissolved state. The resin fine particles are exemplified, for example, by fine particles of: a resin based on acrylic acid, a resin based on maleate ester, a resin based on vinyl acetate, a resin based on carbonate, a resin based on polycarbonate, a resin based on styrene, a resin based on ethylene, a resin based on polyethylene, a resin based on propylene, a resin based on polypropylene, a resin based on urethane, a resin based on polyurethane, a resin based on polyester, and a resin of copolymer of the above-described resins, etc.; the resin fine particles, however, are preferably fine particles of an acrylic resin.

As the resin fine particles, for example, a resin having a glass-transition temperature (Tg) in a range of 0° C. to 200° C. inclusive is used. The glass transition temperature (Tg) is more preferably in a range of 20° C. to 180° C. inclusive, and further more preferably in a range of 30° C. to 150° C. inclusive.

As the emulsion, for example, a commercially available product may be used. The commercially available product is exemplified, for example, by “SUPERFLEX (“SUPERFLEX” is a registered trademark of DKS CO., LTD (DAI-ICHI KOGYO SEIYAKU CO., LTD)) 870” (Tg: 71° C.), “SUPERFLEX 150” (Tg: 40° C.) manufactured by DKS CO., LTD; “Mowinyl (“Mowinyl” is a registered trademark of Japan Coating Resin Co., Ltd.) 6760” (Tg: −28° C.) and “Mowinyl DM774” (Tg: 33° C.) manufactured by Japan Coating Resin Co., Ltd.; “Polysor (“Polysor” is a registered trademark of Resonac Holdings Corporation) AP-3270N” (Tg: 27° C.) manufactured by Resonac Holding Corporation; “HILOS-X (“HILOS-X” is a registered trademark of SEIKO PMC CORPORATION) KE-1062” (Tg: 112° C.), and “HILOS-X QE-1042” (Tg: 69° C.) manufactured by SEIKO PMC CORPORATION; etc.

The average particle diameter of the resin fine particles is, for example, in a range of 30 nm to 200 nm inclusive. The average particle diameter can be measured by, for example, by using a dynamic light scattering particle diameter distribution measuring apparatus “LB-550” (trade name) manufactured by HORIBA, Ltd., as an arithmetic average diameter.

A content amount (R) of the resin fine particles in the entire amount of the ink is, for example, preferably in a range of 0.1 wt % to 30 wt % inclusive, more preferably in a range of 0.5 wt % to 20 wt % inclusive, further more preferably in a range of 1.0 wt % to 15 wt % inclusive. As the resin fine particles, one kind of the resin fine particles may be used singly, or 2 (two) kinds or more of the resin fine particles may be used in combination.

The colorant is, for example, a pigment which is dispersible in water by, for example, a resin for dispersing pigment (resin dispersant). The colorant is exemplified, for example, by carbon black, an inorganic pigment, an organic pigment, etc. The carbon black is exemplified, for example, by furnace black, lamp black, acetylene black, channel black, etc. The inorganic pigment is exemplified, for example, by titanium oxide, inorganic pigments based on iron oxide, inorganic pigments based on carbon black, etc. The organic pigment is exemplified, for example, by azo-pigments such as azo lake, insoluble azo-pigment, condensed azo-pigment, chelate azo-pigment, etc.; polycyclic pigments such as phthalocyanine pigment, perylene and perinone pigments, anthraquinone pigment, quinacridone pigment, dioxadine pigment, thioindigo pigment, isoindolinone pigment, quinophthalone pigment etc.; dye lake pigments such as basic dye type lake pigment, acid dye type lake pigment, etc.; nitro pigment; nitroso pigment; aniline black daylight fluorescent pigment; and the like.

A solid content amount of the colorant (colorant solid component amount) in the entire amount of the ink is not particularly limited, and may be appropriately determined according to, for example, desired optical density or chromaticness, etc. The colorant solid component amount is, for example, preferably in a range of 0.1 wt % to 20.0 wt % inclusive, more preferably in a range of 1.0 wt % to 15.0 wt % inclusive. The colorant solid component amount is the weight only of the pigment, and does not include the weight of the resin fine particles. One kind of the colorant may be used singly, or two or more kinds of the colorant may be used in combination.

The organic solvent is not particularly limited, and any organic solvent is usable. The organic solvent is exemplified, for example, by: propylene glycol, ethylene glycol, 1,2-butanedioal, propylene glycol monobutyl ether, dipropylene glycol monopropyl ether, triethylene glycol monobutyl ether, 1,2-hexianediol, 1,6-hexianediaol, etc.; and glycol ether having a propylene oxide group is preferred. Examples of other organic solvent include, for example, alkylalcohols having a carbon number of 1 to 4 such as: methyl alcohol, ethyl alcohol, n-propyl alcohol, isopropyl alcohol, n-butyl alcohol, sec-butyl alcohol, tert-butyl alcohol, etc.; alkylene glycols in each of which an alkylene group includes 2 to 6 carbon atoms such as: ethylene glycol, propylene glycol, butylene glycol, triethylene glycol, 1,2,6-hexanetriol, thiodiglycol, hexylene glycol, diethylene glycol, etc.; lower alkyl ethers of alkylene glycols such as: glycerin, ethylene glycol monomethyl (or ethyl, propyl, butyl) ether, diethylene glycol monomethyl (or ethyl, propyl, butyl) ether, triethylene glycol monomethyl (or ethyl, propyl, butyl, hexyl) ether, tetraethylene glycol monomethyl (or ethyl, propyl, butyl, hexyl) ether, propylene glycol monomethyl (or ethyl, propyl, butyl) ether, dipropylene glycol monomethyl (or ethyl, propyl, butyl) ether, tripropylene glycol monomethyl (or ethyl, propyl, butyl) ether, tetra propylene glycol monomethyl (or ethyl) ether; N-methyl-2-pyrrolidone; 2-pyrrolidone; 1,3-dimethyl 2-imidazolidinone; etc.

A content amount of the organic solvent in the entire amount of the ink is preferred that an organic solvent which exists, as a simple substance, as a liquid at 25° C. is preferably 50 wt % or less, more preferably 40 wt % or less, with respect to the entire amount of the ink. The water is preferably ion-exchange water or purified water (pure water). A content amount of the water with respect to the entire amount of the ink is, for example, preferably within a range of 15 wt % to 95 wt % inclusive, more preferably within a range of 25 wt % to 85 wt % inclusive. The content amount of the water may be, for example, a balance of the other components.

The ink may further include a conventionally known additive, as necessary. The additive is exemplified, for example, by surfactants, pH-adjusting agents, viscosity-adjusting agents, surface tension-adjusting agents, antiseptics, fungicides, leveling agents, antifoaming agents, light stabilizing agents, antioxidants, drying preventive agents for nozzle, polymer components such as emulsion, dye, etc. The surfactants may further include cationic surfactants, anionic surfactants or nonionic surfactants. A commercially available product may be used as these surfactants, which is exemplified, by: “OLFIN (“OLFIN” is a registered trademark of Nissin Chemical Industry Co., Ltd.) E1010”, “OLFIN E1006”, and “OLFIN E1004”, “SILFACE (“SILFACE” is a registered trademark of Nissin Chemical Industry Co., Ltd.) SAG503A”, “SILFACE SAG002” manufactured by Nissin Chemical Industry Co., Ltd. The content amount of the surfactant in the entire amount of the ink is, for example, 5 wt % or less, 3 wt % or less, and in a range of 0.1 wt % to 2 wt % inclusive. The viscosity-adjusting agents are exemplified, for example, by polyvinyl alcohol, cellulose, water-soluble resin, etc.

The ink can be prepared, for example, by uniformly mixing the resin fine particles, the colorant, the organic solvent, the water, and an optionally other additive(s) as necessary, by a conventionally known method, and then removing any non-dissolved matter with a filter, etc.

### (Buffer Tank)

The buffer tank 13 is provided as buffer tanks 13 each of which is connected to a corresponding cartridge 12 among the cartridges 12 (FIG. 1) by a tube, etc., and the liquid is supplied to each of the buffer tanks 13 from one of the cartridges 12. Further, each of the buffer tanks 13 is disposed on the liquid ejecting head 20 and communicates with the first nozzles 23a or the second nozzles 23b by a liquid channel. A filter 13a is disposed in the liquid channel. The liquid passes through the filter 13a, flows through the liquid channel, and is supplied to the first nozzle 23a or the second nozzle 23b. In a case where the liquid passes through the filter 13a, an air bubble contained in the liquid is separated and retained in an upper portion of each of the buffer tanks 13.

### (Maintenance Unit)

The maintenance unit 30 includes a cap which is configured to cover the ejection surface of the liquid ejecting head 20. The cap includes a first cap 31a configured to cover the first ejection surface 21a, and a second cap 31b configured to cover the second ejection surface 21b. The first cap 31a and the second cap 31b are each made of an elastic material such as silicon rubber, etc., and are integrally formed. Each of the first cap 31a and the second cap 31b has a shape of a box of which upper portion is open, includes a through hole, and is connected to a tube 39 via the through hole.

Further, the maintenance unit 30 includes a displacement device 32 (FIG. 2) configured to displace the caps 31a, 31b. The displacement device 32 displaces each of the caps 31a, 31b between a contact position and a separate position. Accordingly, each of the caps 31a, 31b changes the state thereof between a capping state and an uncapping state.

That is, in the capping state, the first cap 31a makes contact with the first ejection surface 21a at the contact position to cover the first nozzles 23a which are open in the first ejection surface 21a. In the capping state, the second cap 31b makes contact with the second ejection surface 21b at the contact position to cover the second nozzles 23b which are open in the second ejection surface 21b. This reduces drying of the first liquid from the first nozzles 23a and drying of the second liquid from the second nozzles 23b. On the other hand, in the uncapping state, the first cap 31a is away from the first ejection surface 21a at the separate position to expose the first ejection surface 21a. In the uncapping state, the second cap 31b is away from the second ejection surface 21b at the separate position to expose the second ejection surface 21b.

Furthermore, the maintenance unit 30 has an exhaust path 33a, an exhaust body 33b, and an exhaust cap 33c. The exhaust path 33a is connected to the upper portion of each of the buffer tanks 13, and is open in an exhaust surface 33b1, which is the lower surface of the exhaust body 33b. Air bubbles accumulated in the upper portion of each of the buffer tanks 13 pass through the exhaust path 33a and are exhausted from each of the buffer tanks 13. The exhaust cap 33c is made of an elastic material such as silicon rubber, has a shape of a box of which upper portion is open, and has a through hole via which the exhaust cap 33c is connected to the tube 39.

The exhaust cap 33c is configured to be displaceable between a contact position and a separate position by the displacement device 32. Accordingly, the exhaust cap 33c changes the state thereof between a capping state and an uncapping state. In the capping state, the exhaust cap 33c makes contact with the exhaust surface 33b1 at the contact position and covers the opening of the exhaust path 33a. On the other hand, in the separate position, the exhaust cap 33c is away from the exhaust surface 33b1 and the opening of the exhaust path 33a is exposed to the outside.

Further, the maintenance unit 30 includes a cleaning liquid tank 34 configured to store a cleaning liquid, a waste liquid tank 35 configured to store waste liquid, and a suction pump 36. The cleaning liquid tank 34 stores the cleaning liquid and supplies the cleaning liquid to the caps 31a and 31b. The cleaning liquid is a liquid which can clean (dilute) the first liquid and the second liquid, does not contain a solid component, and contains, for example, an organic solvent, a surfactant, and a water-soluble solvent including water, etc. In other words, the cleaning liquid may be a liquid obtained by removing the resin fine particles and the colorant from the first liquid and the second liquid. The waste liquid tank 35 has a space configured to store the waste liquid which is the liquid exhausted from the first and second nozzles 23a and 23b and the caps 31a and 31b, and the space is open to the atmosphere.

The suction pump 36 is, for example, a tube pump, and is disposed in a tube 39 (tube 39a) which is connected to a switching valve 37 and the waste liquid tank 35. The suction pump 36 performs suction from the switching valve 37 to the waste liquid tank 35 in a case where a roller rotates while being pressed against the tube 39a. In a state that the roller is not pressed against the tube 39a, the suction pump 36 is in an atmospheric open state in which the tube 39a is open to the atmosphere via the waste liquid tank 35.

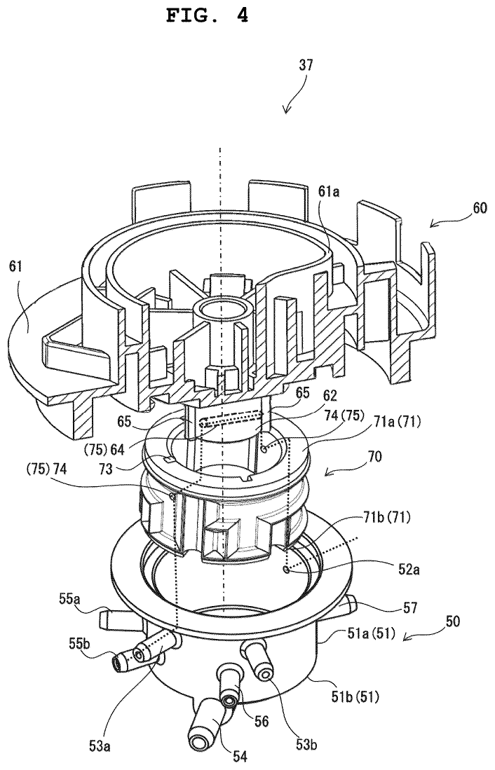

The maintenance unit 30 further includes the switching valve 37 and the rotation device 38 (FIG. 2). The switching valve 37 has a fixed member 50 (FIG. 4) and a rotation member 60 (FIG. 4), and is configured to communicate with each of the first cap 31a, the second cap 31b, the exhaust cap 33c, the suction pump 36, the cleaning liquid tank 34, and the waste liquid tank 35 by one of the tubes 39. The rotation device 38 rotates the rotation member 60 with respect to the fixed member 50, to thereby change a communication state among the first cap 31a, the second cap 31b, the exhaust cap 33c, the suction pump 36, the cleaning liquid tank 34, and the waste liquid tank 35.

### (Switching Valve)

As depicted in FIG. 4, the switching valve 37 has the fixed member 50, the rotation member 60, and a channel member 70. The rotation member 60 is made, for example, of resin, and has a gear part 61 and a path part 62. The gear part 61 has a shape of a disc, and is connected to the rotation device 38 (FIG. 2). The rotation device 38 is driven to cause the rotation member 60 to rotate with respect to the fixed member 50. The central axis of the rotation member 60 and the central axis of the fixed member 50 coincide with each other, and the rotation member 60 rotates around the central axis.

The path part 62 has a columnar shape, has a central axis which coincides with the central axis of the gear part 61, and protrudes downward from the gear part 61. The path part 62 has a first cleaning liquid path 64. The first cleaning liquid path 64 extends linearly along the radial direction of the path part 62, penetrates the path part 62, and is open in the outer circumferential surface of the path part 62. Further, the path part 62 includes a plurality of protruding parts 65 protruding from the outer circumferential surface. Each of the plurality of protruding parts 65 extends in a direction parallel to the central axis of the path part 62, for example, in the up-down direction.

The channel member 70 is made of an elastic material such as rubber and has a second main body 71. The second main body 71 includes a second side wall 71a and a second bottom wall 71b. The second side wall 71a has a cylindrical shape, and the path part 62 is inserted inside the second side wall 71a. The central axis of the second side wall 71a coincides with the central axis of the path part 62, and the inner circumferential surface of the second side wall 71a contacts the outer circumferential surface of the path part 62 in a watertight manner.

Further, recessed parts 73 are defined in the outer circumferential surface of the second side wall 71a. Each of the recessed parts 73 extends in a direction parallel to the central axis of the second side wall 71a, for example, along the up-down direction. Each of the plurality of protruding parts 65 of the path part 62 is fitted into one of the recessed parts 73, of the second side wall 71a, corresponding thereto, and thus the channel member 70 is attached to the rotation member 60. The channel member 70 rotates together with the rotation member 60 with respect to the fixed member 50 by engaging with the path part 62 in the circumferential direction around the central axis.

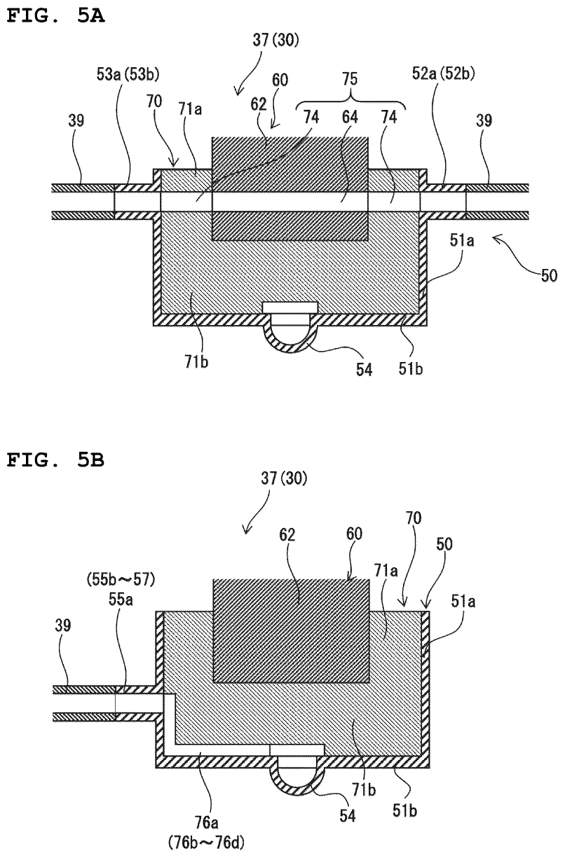

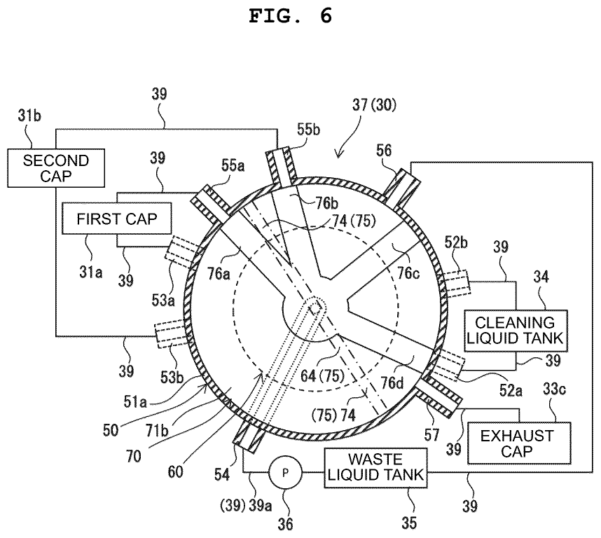

Furthermore, two second cleaning liquid paths 74 are defined in the second side wall 71a. Each of the two second cleaning liquid paths 74 extends along the radial direction of the second side wall 71a and penetrates the second side wall 71a. As depicted in FIG. 5A and FIG. 6, the first cleaning liquid path 64 is located between the two second cleaning liquid paths 74, and these paths (the two second cleaning liquid paths and the first cleaning liquid path 64) extend along the same straight line. In the radial direction of the channel member 70, an opening of each of the two second cleaning liquid paths 74 and one of the openings of the first cleaning liquid path 64 face each other, and the two second cleaning liquid paths 74 are connected to the first cleaning liquid path 64. With this, the first cleaning liquid path 64 and the two second cleaning liquid paths 74 form a cleaning liquid path 75. The cleaning liquid path 75 extends linearly along the radial direction of the channel member 70 and is open in the outer circumferential surface of the channel member 70.

As depicted in FIG. 5B and FIG. 6, a plurality of grooves are defined in the outer circumferential surface of the second side wall 71a and the lower surface of the second bottom wall 71b. The plurality of grooves define a plurality of waste liquid paths, for example, a first waste liquid path 76a, a second waste liquid path 76b, a third waste liquid path 76c, and a fourth waste liquid path 76d. These first to fourth waste liquid paths 76a to 76d extend from the center of the lower surface of the second bottom wall 71b to the outer circumferential surface of the second side wall 71a, along the radial direction of the lower surface of the second bottom wall 71b, and further extend upward from the lower surface of the second bottom wall 71b at the outer circumferential surface of the second side wall 71a.

As a result, the first to fourth waste liquid paths 76a to 76d overlap and communicate with one another at the center of the lower surface of the channel member 70. Further, the first to fourth waste liquid paths 76a to 76d are located so as to be shifted from one another in the circumferential direction of the central axis of the channel member 70 on the outer circumferential surface of the second bottom wall 71b. Furthermore, the first to fourth waste liquid paths 76a to 76d are located below the cleaning liquid path 75 in the up-down direction, and therefore do not communicate with the cleaning liquid path 75.

As depicted in FIG. 4, the fixing member 50 has a first main body 51 which supports the channel member 70. The first main body 51 is made, for example, of resin, and has a first side wall 51a and a first bottom wall 51b. The first side wall 51a has a cylindrical shape; the first bottom wall 51b has a circular shape, and covers a lower opening of the first side wall 51a.

The channel member 70 is accommodated inside the first side wall 51a, and the central axis of the first side wall 51a coincides with the central axis of the channel member 70. The inner circumferential surface of the first side wall 51a contacts the outer circumferential surface of the second side wall 71a in a watertight manner so that the channel member 70 is rotatable with respect to the first side wall 51a. Further, the upper surface of the first bottom wall 51b contacts the lower surface of the second bottom wall 71b in a watertight manner. As a result, the first to fourth waste liquid paths 76a to 76d defined in the outer circumferential surface of the second side wall 71a and the lower surface of the second bottom wall 71b of the channel member 70 are covered by the inner circumferential surface of the first side wall 51a and the upper surface of the first bottom wall 51b of the fixed member 50.

Further, the fixed member 50 has a cleaning liquid upstream port. As depicted in FIG. 6, the cleaning liquid upstream port includes a first cleaning liquid upstream port 52a and a second cleaning liquid upstream port 52b. Each of the first and second cleaning liquid upstream ports 52a and 52b has a tubular shape, penetrates the first side wall 51a of the main body, and is open in the inner circumferential surface of the first side wall 51a. The first cleaning liquid upstream port 52a and the second cleaning liquid upstream port 52b are disposed at the same height in the up-down direction, and the opening of the first cleaning liquid upstream port 52a and the opening of the second cleaning liquid upstream port 52b face each other in the radial direction of the first side wall 51a.

Each of the first and second cleaning liquid upstream ports 52a and 52b is a hollow protrusion protruding from the outer circumferential surface of the first side wall 51a. Each of the first and second cleaning liquid upstream ports 52a and 52b is connected to one end of a tube 39, and the other end of the tube 39 is connected to the cleaning liquid tank 34. As a result, each of the first and second cleaning liquid upstream ports 52a and 52b communicates with the cleaning liquid tank 34 via the tube 39.

Furthermore, the fixed member 50 has a cleaning liquid downstream port. As depicted in FIG. 4 and FIG. 6, the cleaning liquid downstream port includes a first cleaning liquid downstream port 53a and a second cleaning liquid downstream port 53b. Each of the first and second cleaning liquid downstream ports 53a and 53b has a tubular shape, penetrates the first side wall 51a of the main body, and is open in the inner circumferential surface of the first side wall 51a. The first cleaning liquid downstream port 53a and the second cleaning liquid downstream port 53b are disposed at the same height in the up-down direction, and the opening of the first cleaning liquid downstream port 53a and the opening of the second cleaning liquid downstream port 53b face each other in the radial direction of the first side wall 51a.

Each of the first and second cleaning liquid downstream ports 53a and 53b is a hollow protrusion protruding from the outer circumferential surface of the first side wall 51a. The first cleaning liquid downstream port 53a is connected to one end of a tube 39, and the other end of this tube 39 is connected to the first cap 31a. As a result, the first cleaning liquid downstream port 53a communicates with the first cap 31a via the tube 39. Further, the second cleaning liquid downstream port 53b is connected to one end of a tube 39, and the other end of this tube 39 is connected to the second cap 31b. As a result, the second cleaning liquid downstream port 53b communicates with the second cap 31b via the tube 39.

The first and second cleaning liquid upstream ports 52a and 52b and the first and second cleaning liquid downstream ports 53a and 53b are disposed at the same height in the up-down direction as the cleaning liquid path 75 of the rotation member 60 and the channel member 70. The rotation member 60 and the channel member 70 rotate with respect to the fixed member 50, thereby changing a communication state between the cleaning liquid path 75 and each of the first and second cleaning liquid upstream ports 52a and 52b and the first and second cleaning liquid downstream ports 53a and 53b.

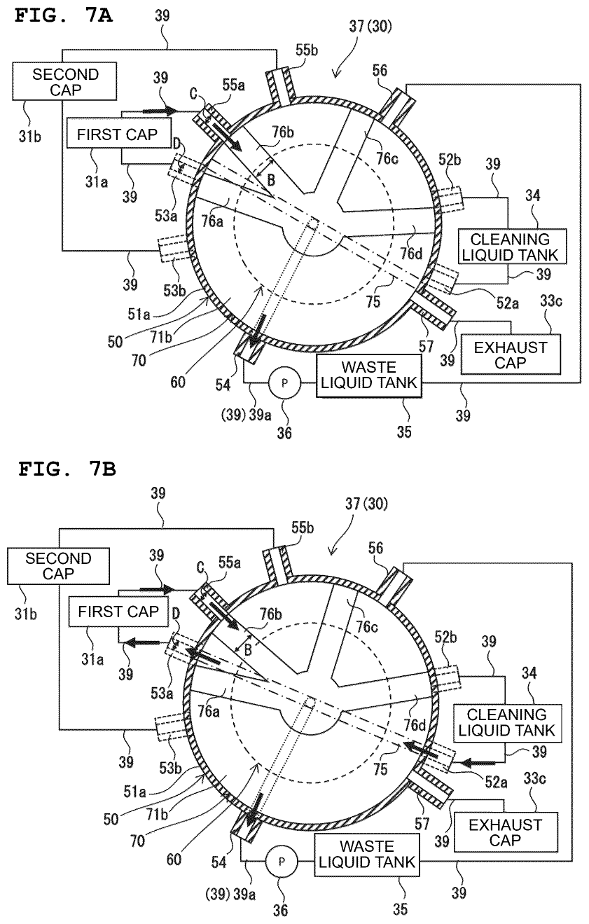

That is, as depicted in FIGS. 5A and 7B, the cleaning liquid path 75 is aligned on the same straight line with the first cleaning liquid upstream port 52a and the first cleaning liquid downstream port 53a. Further, in the radial direction of the channel member 70, the openings of the cleaning liquid path 75 face, respectively, the opening of the first cleaning liquid upstream port 52a and the opening of the first cleaning liquid downstream port 53a. As a result, the cleaning liquid path 75 communicates with the first cleaning liquid upstream port 52a and the first cleaning liquid downstream port 53a. In this case, the cleaning liquid path 75 does not communicate with the second cleaning liquid upstream port 52b and the second cleaning liquid downstream port 53b.

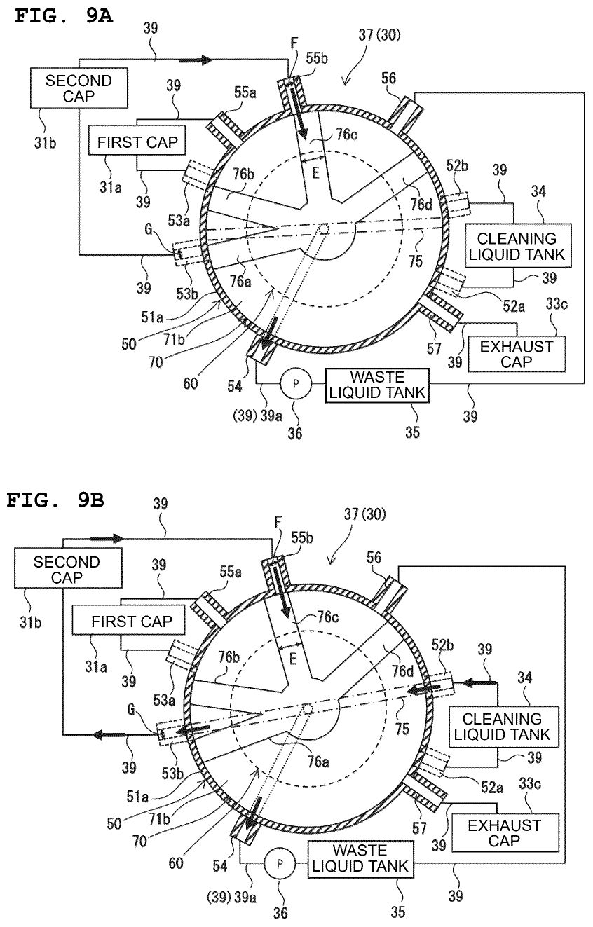

Further, as depicted in FIG. 5A and FIG. 9B, the cleaning liquid path 75 is aligned on the same straight line with the second cleaning liquid upstream port 52b and the second cleaning liquid downstream port 53b. Further, in the radial direction of the channel member 70, the openings of the cleaning liquid path 75 face, respectively, the opening of the second cleaning liquid upstream port 52b and the opening of the second cleaning liquid downstream port 53b. As a result, the cleaning liquid path 75 communicates with the second cleaning liquid upstream port 52b and the second cleaning liquid downstream port 53b. In this case, the cleaning liquid path 75 does not communicate with the first cleaning liquid upstream port 52a and the first cleaning liquid downstream port 53a.

Furthermore, as depicted in FIG. 4, FIG. 5B, and FIG. 6, the fixed member 50 has the intake port 54. The intake port 54 has a substantially tubular shape and penetrates the center of the first bottom wall 51b in the up-down direction. At the center of the second bottom wall 71b which faces the center of the first bottom wall 51b, the intake port 54 is connected to the first to fourth waste liquid paths 76a to 76d defined in the lower surface of the second bottom wall 71b.

Moreover, the intake port 54 is a hollow protrusion protruding from the lower surface of the first bottom wall 51b of the main body. The intake port 54 extends from the center of the first bottom wall 51b along the radial direction of the first bottom wall 51b beyond the outer circumferential surface of the first side wall 51a. The intake port 54 is connected to one end of a tube 39, and the other end of the tube 39 is connected to the waste liquid tank 35. As a result, the intake port 54 communicates with the waste liquid tank 35 by the tube 39. The suction pump 36 is disposed in the tube 39a located between the intake port 54 and the waste liquid tank 35.

Further, the fixed member 50 has a waste liquid port. The waste liquid port includes a first waste liquid port 55a and a second waste liquid port 55b. Each of the first and second waste liquid ports 55a and 55b has a tubular shape, penetrates the first side wall 51a, and is open in the inner circumferential surface of the first side wall 51a.

The first waste liquid port 55a is a hollow protrusion protruding from the outer circumferential surface of the first side wall 51a, and is connected to one end of a tube 39. The other end of the tube 39 is connected to the first cap 31a, thereby causing the first waste liquid port 55a to communicate with the first cap 31a via the tube 39. The second waste liquid port 55b is a hollow protrusion protruding from the outer circumferential surface of the first side wall 51a, and is connected to one end of a tube 39. The other end of the tube 39 is connected to the second cap 31b, thereby causing the second waste liquid port 55b to communicate with the second cap 31b via the tube 39.

Furthermore, the fixed member 50 has an exhaust port 57. The exhaust port 57 has a tubular shape, penetrates the first side wall 51a of the main body, and is open in the inner circumferential surface of the first side wall 51a. The exhaust port 57 is a hollow protrusion protruding from the outer circumferential surface of the first side wall 51a, and is connected to one end of a tube 39. The other end of the tube 39 is connected to the exhaust cap 33c, thereby causing the exhaust port 57 to communicate with the exhaust cap 33c via the tube 39.

Moreover, the fixed member 50 has an atmosphere port 56. The atmosphere port 56 has a tubular shape, penetrates the first side wall 51a of the main body, and is open in the inner circumferential surface of the first side wall 51a. The atmosphere port 56 is a hollow protrusion protruding from the outer circumferential surface of the first side wall 51a, and is connected to one end of a tube 39. This tube 39 is connected to the waste liquid tank 35 which is open to the atmosphere. In a case where the intake port 54 disposed in this tube 39 is in an atmospheric open state, the atmosphere port 56 is open to the atmosphere via the tube 39 and the waste liquid tank 35.

The first and second waste liquid ports 55a and 55b, the exhaust port 57, and the atmosphere port 56 are disposed below the first and second cleaning liquid upstream ports 52a and 52b and the first and second cleaning liquid downstream ports 53a and 53b in the up-down direction. These ports 55a to 57 are open in the inner circumferential surface of the first side wall 51a at mutually different positions in the circumferential direction of the first side wall 51a. Further, the first to fourth waste liquid paths 76a to 76d of the channel member 70 are open in the outer circumferential surface of the second side wall 71a at mutually different positions in the circumferential direction of the second side wall 71a.

The rotation member 60 and the channel member 70 rotate with respect to the fixed member 50 in a state that the inner circumferential surface of the first side wall 51a and the outer circumferential surface of the second side wall 71a face each other. This changes a communication state between the ports 55a to 57 and the first to fourth waste liquid paths 76a to 76d. Note that the communication state between one opening of each of the first to fourth waste liquid paths 76a to 76d and the ports 55a to 57 changes in accordance with the rotation of the rotation member 60, whereas the other opening of each of the first to fourth waste liquid paths 76a to 76d is connected to the intake port 54 regardless of the rotation of the rotation member 60.

That is, as depicted in FIG. 5B, FIG. 7A, and FIG. 7B, the opening of the second waste liquid path 76b faces the opening of the first waste liquid port 55a in the radial direction of the channel member 70. As a result, the second waste liquid path 76b communicates with the first waste liquid port 55a. Therefore, the first cap 31a communicates with the waste liquid tank 35 via the tube 39, the first waste liquid port 55a, the second waste liquid path 76b, and the intake port 54.

Further, as depicted in FIG. 5B, FIG. 9A, and FIG. 9B, the opening of the third waste liquid path 76c faces the opening of the second waste liquid port 55b in the radial direction of the channel member 70. As a result, the third waste liquid path 76c communicates with the second waste liquid port 55b. Therefore, the second cap 31b communicates with the waste liquid tank 35 via the tube 39, the second waste liquid port 55b, the third waste liquid path 76c, and the intake port 54.

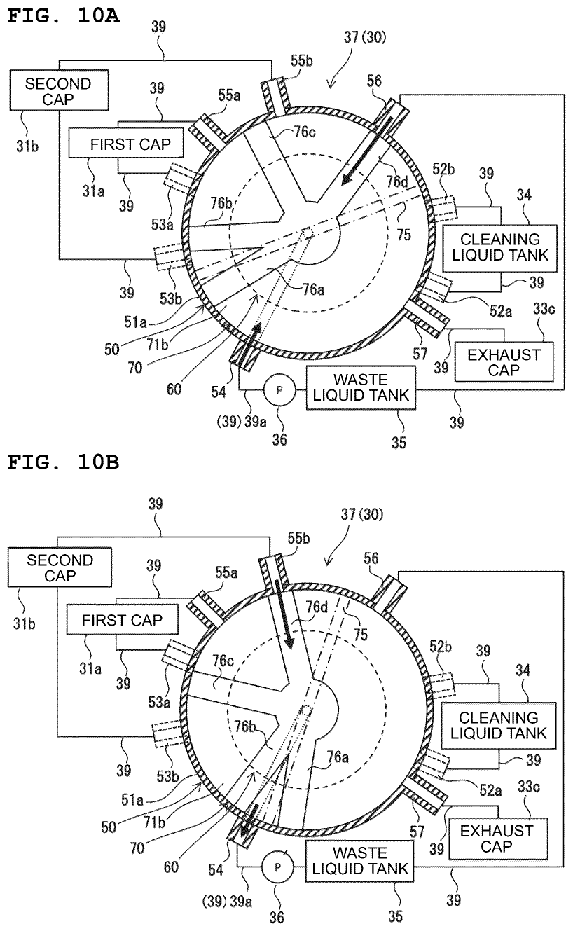

Furthermore, as depicted in FIG. 5B and FIG. 10A, the opening of the fourth waste liquid path 76d faces the opening of the atmosphere port 56 in the radial direction of the channel member 70. As a result, the fourth waste liquid path 76d communicates with the atmosphere port 56. Therefore, the waste liquid tank 35 communicates with the waste liquid tank 35 via the tube 39, the atmosphere port 56, the fourth waste liquid path 76d, and the intake port 54.

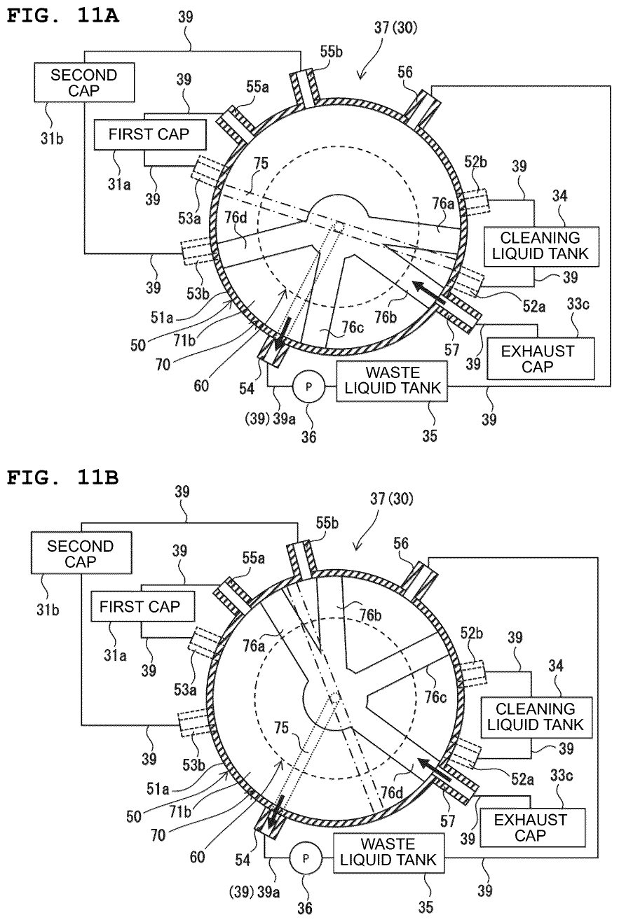

Moreover, as depicted in FIG. 5B and FIG. 11B, the opening of the fourth waste liquid path 76d faces the opening of the exhaust port 57 in the radial direction of the channel member 70. As a result, the fourth waste liquid path 76d communicates with the exhaust port 57. Therefore, the exhaust cap 33c communicates with the waste liquid tank 35 via the tube 39, the exhaust port 57, the fourth waste liquid path 76d, and the intake port 54.

As depicted in FIG. 7A and FIG. 7B, a size B of the second waste liquid path 76b in a direction orthogonal to a direction parallel to the radial direction and the central axis of the channel member 70 is equal to or greater than a total size (C+D) of a size C of the first waste liquid port 55a and a size D of the first cleaning liquid downstream port 53a in a direction orthogonal to the direction parallel to the radial direction and the central axis of the fixed member 50. For example, the size B of the second waste liquid path 76b is 2.0 mm, and each of the size C of the first waste liquid port 55a and the size D of the first cleaning liquid downstream port 53a is 0.8 mm. Therefore, in a case that the rotation member 60 is rotated by, for example, 6°, the communication state can be changed between a state that the cleaning liquid path 75 does not communicate with the first cleaning liquid downstream port 53a as depicted in FIG. 7A and a state that the cleaning liquid path 75 communicates with the first cleaning liquid downstream port 53a as depicted in FIG. 7B, while maintaining a state that the second waste liquid path 76b communicates with the first waste liquid port 55a.

Further, as depicted in FIGS. 9A and 9B, a size E of the third waste liquid path 76c in the direction orthogonal to the direction parallel to the radial direction and the central axis of the channel member 70 is equal to or greater than a total size (F+G) of a size F of the second waste liquid port 55b and a size G of the second cleaning liquid downstream port 53b in the direction orthogonal to the direction parallel to the radial direction and the central axis of the fixed member 50. For example, the size E of the third waste liquid path 76c is 2.0 mm, and each of the size F of the second waste liquid port 55b and the size G of the second cleaning liquid downstream port 53b is 0.8 mm. Therefore, in a case that the rotation member 60 is rotated by, for example, 6°, the communication state can be changed between a state that the cleaning liquid path 75 does not communicate with the second cleaning liquid downstream port 53b as depicted in FIG. 9A and a state that the cleaning liquid path 75 communicates with the second cleaning liquid downstream port 53b as depicted in FIG. 9B, while maintaining a state that the third waste liquid path 76c communicates with the second waste liquid port 55b.

### (Printing Process)

The controller 40 obtains image data of the object image of the printing process from the memory 42 or the communication interface 43, and executes the printing process based on the image data. In this printing process, the controller 40 executes a pass operation based on partial image data of the image data, and causes the liquids to be ejected from the first and second nozzles 23a and 23b of the liquid ejecting head 20 to the print medium A while causing the liquid ejecting head 20 to move rightward or leftward. Further, the controller 40 executes a conveying operation of conveying the print medium A forward. In this way, the controller 40 executes the pass operation and the conveying operation, thereby forming a plurality of partial images along the front-rear direction, and printing an image constructed of the plurality of partial images on the print medium A.

### (Maintenance Process)

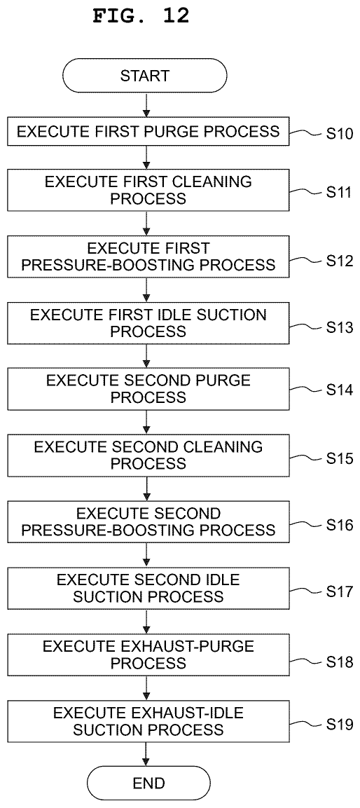

A maintenance process of the liquid ejecting head 20 is executed by the controller 40 in accordance with the flowchart of FIG. 12. This maintenance process is executed, for example, periodically or in response to a command from an input device or the external device capable of communicating with the controller 40.

In a case that the liquid ejecting apparatus 10 is in a standby state in which neither the printing process nor the maintenance process is being performed, each of the first cap 31a, the second cap 31b, and the exhaust cap 33c is in the capping state. Further, the rotation member 60 is located at the standby position depicted in FIG. 6. In this standby position, the first waste liquid path 76a communicates with the first waste liquid port 55a, and the second waste liquid path 76b communicates with the second waste liquid port 55b. Furthermore, the suction pump 36 is in the atmospheric open state.

This causes the first cap 31a and the second cap 31b to be open to the atmosphere via the suction pump 36 and the waste liquid tank 35. This reduces the variation in pressure inside the first cap 31a and the second cap 31b, thereby preventing the liquids from being unnecessarily ejected from the first nozzles 23a and the second nozzles 23b.

In the maintenance process, the controller 40 executes a first purge process (step S10). In the first purge process, the controller 40 rotates the rotation member 60 from the standby position to the first purge position in FIG. 7A. When the rotation member 60 is located at the first purge position, the second waste liquid path 76b communicates with the first waste liquid port 55a and the intake port 54, and the cleaning liquid path 75 does not communicate with the first cleaning liquid upstream port 52a and the first cleaning liquid downstream port 53a. Further, each of the first, third and fourth waste liquid paths 76a, 76c and 76d does not communicate with any of the second waste liquid port 55b, the atmosphere port 56 and the exhaust port 57, and the cleaning liquid path 75 does not communicate with any of the second cleaning liquid upstream port 52b and the second cleaning liquid downstream port 53b. In this case, the first cap 31a communicates with the tube 39a in which the suction pump 36 is disposed.

Then, the controller 40 drives the suction pump 36 in a state that the first cap 31a is in the capping state and that the rotation member 60 is located at the first purge position. With this, the suction is performed inside the first cap 31a covering the first ejection surface 21a, thereby sucking the first liquid from the first nozzles 23a which are open in the first ejection surface 21a. This first liquid flows from the first cap 31a through the tube 39, the first waste liquid port 55a, the second waste liquid path 76b, the intake port 54, and the tube 39a in this order, and is exhausted into and stored in the waste liquid tank 35. By such a first purge process, the first liquid which has dried and thereby become viscous is exhausted from the first nozzles 23a, thereby reducing the unsatisfactory ejection from the first nozzles 23a.

After executing the first purge process, the controller 40 executes a first cleaning process (step S11). In the first cleaning process, the controller 40 rotates the rotation member 60 from the first purge position to a first cleaning position depicted in FIG. 7B. When the rotation member 60 is located at the first cleaning position, the second waste liquid path 76b communicates with the first waste liquid port 55a and the intake port 54, and the cleaning liquid path 75 communicates with the first cleaning liquid upstream port 52a and the first cleaning liquid downstream port 53a. Further, each of the first, third and fourth waste liquid paths 76a, 76c and 76d does not communicate with any of the second waste liquid port 55b, the atmosphere port 56 and the exhaust port 57, and the cleaning liquid path 75 does not communicate with any of the second cleaning liquid upstream port 52b and the second cleaning liquid downstream port 53b. In this case, the first cap 31a communicates with the tube 39a in which the suction pump 36 is disposed, and the first cap 31 also communicates with the cleaning liquid tank 34.

Then, in a state that the first cap 31a is in the capping state and that the rotation member 60 is located at the first cleaning position, the controller 40 drives the suction pump 36. With this, the suction is performed inside the first cap 31a covering the first ejection surface 21a, and negative pressure is generated in a space surrounded by the first ejection surface 21a and the first cap 31a.

The diameter of the first nozzle 23a which is open in the first ejection surface 21a is smaller than the diameters, respectively, of the tube 39, the first cleaning liquid upstream port 52a, the first cleaning liquid downstream port 53a, and the cleaning liquid path 75 each of which communicates with the first cap 31a. Therefore, the channel resistance of the first nozzle 23a is high, and the cleaning liquid is sucked from the cleaning liquid tank 34 more easily as compared with a case that the first liquid is sucked from the first nozzles 23a into the first cap 31a. In other words, the cleaning liquid flows easily into the first cap 31a from the cleaning liquid tank 34. Therefore, in a state that the first liquid is prevented from flowing into the first cap 31a from the first nozzles 23a, the cleaning liquid flows from the cleaning liquid tank 34 through the tube 39, the first cleaning liquid upstream port 52a, the cleaning liquid path 75, the first cleaning liquid downstream port 53a, and the tube 39 in this order, and then flows into the first cap 31a.

Further, the cleaning liquid is accumulated up to the first ejection surface 21a covered by the first cap 31a and contacts the first ejection surface 21a. For example, in a case where the first liquid solidified on the first ejection surface 21a is present, the first liquid solidified on the first ejection surface 21a contacts the cleaning liquid having a similar composition to the composition of the first liquid, and thus the solidified first liquid is easily dissolved in the cleaning liquid. Even in a case where the substance adhered on the first ejection surface 21a is insoluble in the cleaning liquid, the substance adhered to the first ejection surface 21a may move from the first ejection surface 21a to the cleaning liquid. In other words, this cleans the first ejection surface 21a. The cleaning liquid then flows from the first cap 31a through the tube 39, the first waste liquid port 55a, the second waste liquid path 76b, the intake port 54, and the tube 39a in this order, and is exhausted into and stored in the waste liquid tank 35. By such a first cleaning process, the substance adhered to the first ejection surface 21a is removed by the cleaning liquid, thereby preventing the unsatisfactory ejection of the first liquid from the first nozzles 23a otherwise caused due to the substance adhered to the first ejection surface 21a.

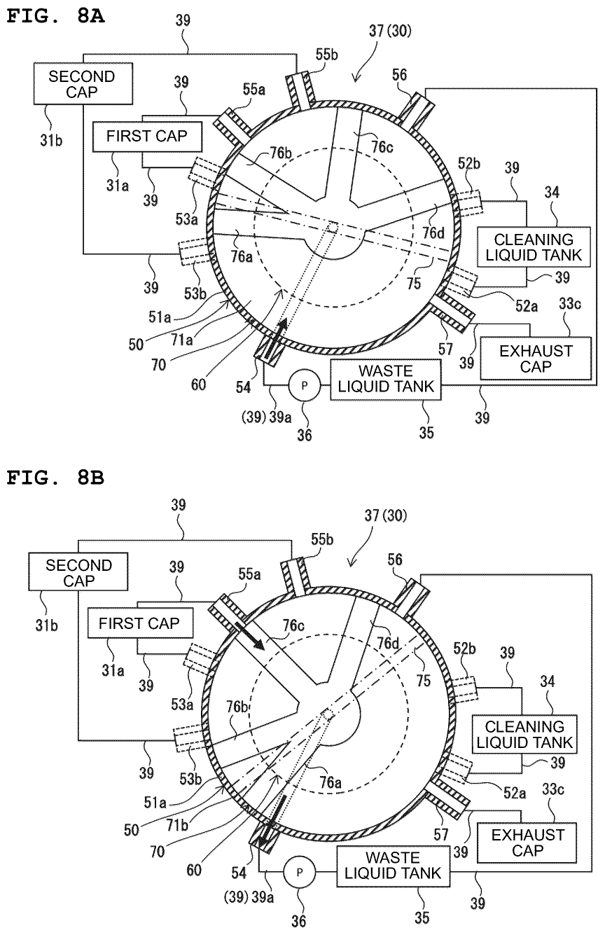

After executing the first cleaning process, the controller 40 executes a first pressure-boosting process (step S12). In the first pressure-boosting process, the controller 40 rotates the rotation member 60 from the first cleaning position to a first pressure-boosting position depicted in FIG. 8A. As a result, each of the first to fourth waste liquid paths 76a to 76d does not communicate with any of the first waste liquid port 55a, the second waste liquid port 55b, the atmosphere port 56 and the exhaust port 57, and the cleaning liquid path 75 does not communicate with any of the first cleaning liquid upstream port 52a, the second cleaning liquid upstream port 52b, the first cleaning liquid downstream port 53a and the second cleaning liquid downstream port 53b.

Then, the controller 40 causes the suction pump 36 to be in the atmospheric open state, in a state that the first cap 31a is in the capping state and the rotation member 60 is located at the first pressure-boosting position. As a result, the air flows from the waste liquid tank 35 through the tube 39a, in which the suction pump 36 is disposed, and the intake port 54, and flows into the first to fourth waste liquid paths 76a to 76d. Then, the pressure of the first to fourth waste liquid paths 76a to 76d becomes the atmospheric pressure or approaches atmospheric pressure. In some cases, the first to fourth waste liquid paths 76a to 76d may temporarily communicate with the second waste liquid port 55b while the channel member 70 is being rotated. Even in such a case, the second liquid can be prevented from being unnecessarily sucked from the second nozzles 23b covered by the second cap 31b which communicates with the second waste liquid port 55b.

After executing the first pressure-boosting process, the controller 40 executes a first idle suction process (step S13). In the first idle suction process, the controller 40 rotates the rotation member 60 from the first pressure-boosting position to a first idle suction position depicted in FIG. 8B. As a result, the third waste liquid path 76c communicates with the first waste liquid port 55a and the intake port 54, and the cleaning liquid path 75 does not communicate with the first cleaning liquid upstream port 52a and the first cleaning liquid downstream port 53a. Further, each of the first, second and fourth waste liquid paths 76a, 76b and 76d does not communicate with any of the second waste liquid port 55b, the atmosphere port 56 and the exhaust port 57, and the cleaning liquid path 75 does not communicate with any of the second cleaning liquid upstream port 52b and the second cleaning liquid downstream port 53b. In this case, the first cap 31a communicates with the tube 39a in which the suction pump 36 is disposed.

Then, the controller 40 changes the state of the first cap 31a from the capping state to the uncapping state, and drives the suction pump 36 in a state that the rotation member 60 is located at the first idle suction position. With this, the first liquid and the cleaning liquid remaining in the first cap 31a pass, together with the air, from the first cap 31a through the tube 39, the first waste liquid port 55a, the third waste liquid path 76c, the intake port 54 and the tube 39a, and are exhausted to the waste liquid tank 35. This reduces the first liquid which is dried in the first cap 31a, thereby preventing the absorption of the water from the first liquid of the first nozzles 23a due to a dried substance (of the first liquid), and preventing the first liquid from drying due to the absorption of water and preventing the unsatisfactory ejection of the first liquid from the first nozzles 23a accompanying with the drying of the first liquid.

After executing the first idle suction process, the controller 40 executes a second purge process (step S14). In the second purge process, the controller 40 rotates the rotation member 60 from the first idle suction position to a second purge position depicted in FIG. 9A. When the rotation member 60 is located at the second purge position, the third waste liquid path 76c communicates with the second waste liquid port 55b and the intake port 54, and the cleaning liquid path 75 does not communicate with the second cleaning liquid upstream port 52b and the second cleaning liquid downstream port 53b. Further, each of the first, second and fourth waste liquid paths 76a, 76b and 76d does not communicate with any of the first waste liquid port 55a, the atmosphere port 56 and the exhaust port 57, and the cleaning liquid path 75 does not communicate with any of the first cleaning liquid upstream port 52a and the first cleaning liquid downstream port 53a. In this case, the second cap 31b communicates with the tube 39a in which the suction pump 36 is disposed.

Then, the controller 40 drives the suction pump 36 in a state that the second cap 31b is in the capping state and that the rotation member 60 is located at the second purge position. With this, the suction is performed inside the second cap 31b covering the second ejection surface 21b, thereby sucking the second liquid from the second nozzles 23b which are open in the second ejection surface 21b. This second liquid flows from the second cap 31b through the tube 39, the second waste liquid port 55b, the third waste liquid path 76c, the intake port 54, and the tube 39a in this order, and the second liquid is exhausted into and retrained in the waste liquid tank 35. By such a second purge process, the second liquid which has dried and thereby become viscous is exhausted from the second nozzles 23b, thereby reducing the unsatisfactory ejection from the second nozzles 23b.

After executing the second purge process, the controller 40 executes a second cleaning process (step S15). In the second cleaning process, the controller 40 rotates the rotation member 60 from the second purge position to a second cleaning position depicted in FIG. 9B. When the rotation member 60 is located at the second cleaning position, the third waste liquid path 76c communicates with the second waste liquid port 55b and the intake port 54, and the cleaning liquid path 75 communicates with the second cleaning liquid upstream port 52b and the second cleaning liquid downstream port 53b. Further, each of the first, second and fourth waste liquid paths 76a, 76b and 76d does not communicate with any of the first waste liquid port 55a, the atmosphere port 56 and the exhaust port 57, and the cleaning liquid path 75 does not communicate with any of the first cleaning liquid upstream port 52a and the first cleaning liquid downstream port 53a. In this case, the second cap 31b communicates with the tube 39a, in which the suction pump 36 is disposed, and with the cleaning liquid tank 34.

Then, the controller 40 drives the pump 36 in a state that the second cap 31b is in the capping state and the rotation member 60 is located at the second cleaning position. With this, the suction is performed inside the second cap 31b covering the second ejection surface 21b, and the negative pressure is generated in a space surrounded by the second ejection surface 21b and the second cap 31b.

The diameter of the second nozzle 23b which is open in the second ejection surface 21b is smaller than the diameter of each of the tube 39, the first cleaning liquid upstream port 52a and the first cleaning liquid downstream port 53a, and the cleaning liquid path 75 which communicate with the second cap 31b. For this reason, the channel resistance of the second nozzle 23b is high, and the cleaning liquid is sucked from the cleaning liquid tank 34 more easily as compared with a case that the second liquid is sucked from the second nozzles 23b into the second cap 31b. In other words, the cleaning liquid flows easily into the second cap 31b from the cleaning liquid tank 34. Therefore, in a state that the second liquid is prevented from flowing into the second cap 31b from the second nozzles 23b, the cleaning liquid flows from the cleaning liquid tank 34 through the tube 39, the second cleaning liquid upstream port 52b, the cleaning liquid path 75, the second cleaning liquid downstream port 53b, and the tube 39 in this order, and flows into the second cap 31b.

Further, the cleaning liquid is accumulated up to the second ejection surface 21b covered by the second cap 31b and contacts the second ejection surface 21b. For example, in a case where the second liquid solidified on the second ejection surface 21b is present, the second liquid solidified on the second ejection surface 21b contacts the cleaning liquid having a similar composition to the composition of the second liquid, and thus the solidified second liquid is easily dissolved in the cleaning liquid. Even in a case where the substance adhered on the second ejection surface 21b is insoluble in the cleaning liquid, the substance adhered to the second ejection surface 21b may move from the second ejection surface 21b to the cleaning liquid. In other words, this cleans the second ejection surface 21b covered by the second cap 31b. The cleaning liquid then flows from the second cap 31b through the tube 39, the second waste liquid port 55b, the third waste liquid path 76c, the intake port 54, and the tube 39a in this order, and is exhausted into and retrained in the waste liquid tank 35. By such a second cleaning process, the substance adhered to the second ejection surface 21b is removed by the cleaning liquid, thereby preventing the unsatisfactory ejection of the liquid from the second nozzles 23b otherwise caused due to the substance adhered to the second ejection surface 21b.

After executing the second cleaning process, the controller 40 executes a second pressure-boosting process (step S16). In the second pressure-boosting process, the controller 40 rotates the rotation member 60 from the second cleaning position to a second pressure-boosting position depicted in FIG. 10A. As a result, the fourth waste liquid path 76d communicates with the atmosphere port 56, each of the first, second and third waste liquid paths 76a, 76b and 76c does not communicate with any of the first waste liquid port 55a, the second waste liquid port 55b, and the exhaust port 57, and the cleaning liquid path 75 does not communicate with any of the first cleaning liquid upstream port 52a, the second cleaning liquid upstream port 52b, the first cleaning liquid downstream port 53a and the second cleaning liquid downstream port 53b.

Then, the controller 40 causes the suction pump 36 to be in the atmospheric open state, in a state that the second cap 31b is in the capping state and that the rotation member 60 is located at the second pressure-boosting position. As a result, the air flows from the waste liquid tank 35 through the tube 39 and the atmosphere port 56 into the first to fourth waste liquid paths 76a to 76d. Further, the air flows from the waste liquid tank 35 through the tube 39a, in which the suction pump 36 is disposed, and through the intake port 54 and flows into the first to fourth waste liquid paths 76a to 76d. Then, the pressure of the first to fourth waste liquid paths 76a to 76d becomes the atmospheric pressure or approaches the atmospheric pressure. In some cases, the first to fourth waste liquid paths 76a to 76d may temporarily communicate with the first waste liquid port 55a while the channel member 70 is being rotated. Even in such a case, the first liquid can be prevented from being unnecessarily sucked from the first nozzles 23b covered by the first cap 31a which communicates with the first waste liquid port 55a.

After executing the second pressure-boosting process, the controller 40 executes a second idle suction process (step S17). In the second idle suction process, the controller 40 rotates the rotation member 60 from the second pressure-boosting position to a second idle suction position depicted in FIG. 10B. As a result, the fourth waste liquid path 76d communicates with the second waste liquid port 55b and the intake port 54, and each of the first, second and third waste liquid paths 76a, 76b and 76c does not communicate with any of the first waste liquid port 55a, the atmosphere port 56 and the exhaust port 57, and the cleaning liquid path 75 does not communicate with any of the first cleaning liquid upstream port 52a, the second cleaning liquid upstream port 52b, the first cleaning liquid downstream port 53a and the second cleaning liquid downstream port 53b. In this case, the second cap 31b communicates with the tube 39a in which the suction pump 36 is disposed.

Then, the controller 40 drives the suction pump 36 in a state that the second cap 31b is changed from the capping state to the uncapping state, and that the rotation member 60 is located at the second idle suction position. With this, the second liquid and the cleaning liquid remaining in the second cap 31b pass, together with the air, from the second cap 31b through the tube 39, the second waste liquid port 55b, the fourth waste liquid path 76d and the tube 39a, and are exhausted to the waste liquid tank 35. This reduces the second liquid which is dried in the second cap 31b, thereby preventing the absorption of the water from the second liquid of the second nozzles 23b due to a dried substance (of the second liquid), and preventing the second liquid from drying due to the absorption of the water and preventing the unsatisfactory ejection of the second liquid from the second nozzles 23b accompanying with the drying of the second liquid.

After executing the second idle suction process, the controller 40 executes an exhaust-purge process (step S18). In the exhaust-purge process, the controller 40 rotates the rotation member 60 from the second idle suction position to an exhaust-purge position depicted in FIG. 11A. As a result, the second waste liquid path 76b communicates with the exhaust port 57 and the intake port 54, and each of the first, third and fourth waste liquid paths 76a, 76c and 76d does not communicate with any of the first waste liquid port 55a, the second waste liquid port 55b and the atmosphere port 56, and the cleaning liquid path 75 does not communicate with any of the first cleaning liquid upstream port 52a, the second cleaning liquid upstream port 52b, the first cleaning liquid downstream port 53a and the second cleaning liquid downstream port 53b. In this case, the exhaust cap 33c communicates with the tube 39a in which the suction pump 36 is disposed.

Then, the controller 40 drives the suction pump 36 in a state that the exhaust cap 33c is in the capping state and that the rotation member 60 is located at the exhaust-purge position. With this, as depicted in FIG. 3 and FIG. 11A, the suction is performed inside the exhaust cap 33c covering the exhaust surface 33b1, and the negative pressure is generated in a space surrounded by the exhaust surface 33b1 and the exhaust cap 33c. The air bubble retained in the upper portion of the buffer tank 13 is sucked by the exhaust path 33a which is open in the exhaust surface 33b1. Then, the air bubble flows from the buffer tank 13 through the exhaust path 33a, the exhaust cap 33c, the tube 39, the exhaust port 57, the second waste liquid path 76b, the intake port 54, and the tube 39a in this order, and is exhausted into the waste liquid tank 35. By this exhaust-purge process, the air bubble is exhausted from the liquid ejecting head 20, thereby reducing the unsatisfactory ejection from the liquid ejecting head 20 otherwise caused due to the air bubble.

After executing the exhaust-purge process, the controller 40 executes an exhaust-idle suction process (step S19). In the exhaust-idle suction process, the controller 40 rotates the rotation member 60 from the exhaust-purge position to an exhaust-idle suction position depicted in FIG. 11B. As a result, the fourth waste liquid path 76d communicates with the exhaust port 57 and the intake port 54, and each of the first, second and third waste liquid paths 76a, 76b and 76c does not communicate with any of the first waste liquid port 55a, the second waste liquid port 55b and the atmosphere port 56, and the cleaning liquid path 75 does not communicate with any of the first cleaning liquid upstream port 52a, the second cleaning liquid upstream port 52b, the first cleaning liquid downstream port 53a and the second cleaning liquid downstream port 53b. In this case, the exhaust cap 33c communicates with the tube 39a in which the suction pump 36 is disposed.

Further, the controller 40 drives the suction pump 36 in a state that the state of the exhaust cap 33c is changed from the capping state to the uncapping state, and that the rotation member 60 is located at the exhaust-idle suction position. With this, the liquid discharged from the liquid ejecting head 20 together with the air bubble and remaining in the exhaust cap 33c passes, together with the air, from the exhaust cap 33c through the tube 39, the exhaust port 57, the fourth waste liquid path 76d, the intake port 54, and the tube 39a, and is exhausted to the waste liquid tank 35.

### First Modification

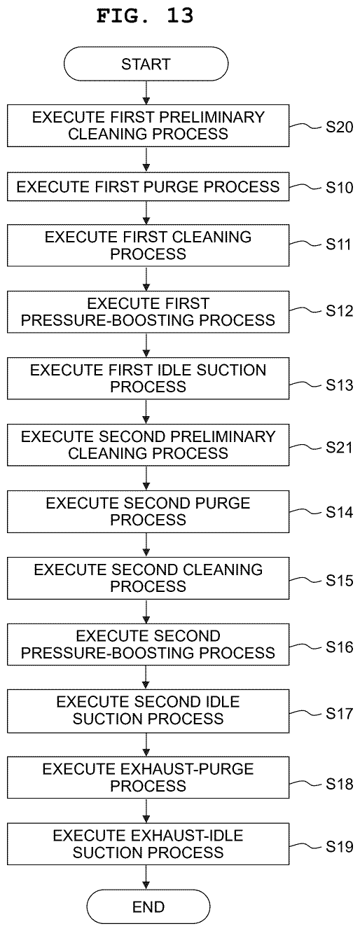

In a liquid ejecting apparatus 10 according to a first modification, the controller 40 further executes, in the above-described embodiment, a first preliminary cleaning process and a second preliminary cleaning process. For example, the controller 40 executes the maintenance process according to the flowchart depicted in FIG. 13. In the flowchart of FIG. 13, the controller 40 executes the first preliminary cleaning process of step S20 before the first purge process of step S10 in the flowchart of FIG. 12. Further, in the flowchart of FIG. 13, the controller 40 executes the second preliminary cleaning process of step S21 before the second purge process of step S14 in the flowchart of FIG. 12.

Specifically, the controller 40 executes the first preliminary cleaning process (step S20) before executing the first purge process (step S10). In the first preliminary cleaning process, the controller 40 rotates the rotation member 60 from the standby position in FIG. 6 to the first cleaning position depicted in FIG. 7B. Then, the controller 40 drives the suction pump 36 in the state that the first cap 31a is in the capping state and that the rotation member 60 is located at the first cleaning position. With this, the suction is performed inside the first cap 31a covering the first ejection surface 21a, and the negative pressure is generated in the space surrounded by the first ejection surface 21a and the first cap 31a.

Therefore, the cleaning liquid flows from the cleaning liquid tank 34 through the first cleaning liquid upstream port 52a, the cleaning liquid path 75, and the first cleaning liquid downstream port 53a in this order, and then flows into the first cap 31a. Then, the cleaning liquid flows from the first cap 31a through the first waste liquid port 55a, the second waste liquid path 76b, and the intake port 54 in this order, and is exhausted into the waste liquid tank 35. By this first preliminary cleaning process, the cleaning liquid adheres to the inside of the first cap 31a and the inside of the waste liquid channel including the first waste liquid port 55a, the second waste liquid path 76b, and the intake port 54. In this way, by causing the cleaning liquid to adhere to the inside of the first cap 31a covering the first ejection surface 21a and the inside of the waste liquid channel in the first preliminary cleaning process, the cleaning liquid is dispersed in the inside of the first cap 31a and the inside of the waste liquid channel; in a case where the first liquid contacts the cleaning liquid, the first liquid is diluted by the cleaning liquid. In a case that the first liquid is diluted, the first liquid thus becomes less likely to solidify, thereby making the first liquid less likely to solidify in the first cap 31a and the waste liquid channel.

Therefore, even in a case where the first liquid is sucked into the first cap 31a by the first purge process (step S10) executed after the first preliminary cleaning process has been executed, the first liquid is not firmly fixed to inside the first cap 31a and the inside of the waste liquid channel, and is easily exhausted from the first cap 31a via the waste liquid channel. Note that the first liquid may be exhausted from the first cap 31a without being accumulated up to the first ejection surface 21a in the first cap 31a. This shortens the time required for the first preliminary cleaning process.

Further, the controller 40 executes the second preliminary cleaning process (step S21) after executing the first idle suction process (step S13) and before executing the second purge process (step S14). In the second preliminary cleaning process, the controller 40 rotates the rotation member 60 from the standby position to the second cleaning position depicted in FIG. 9B. Then, the controller 40 drives the suction pump 36 in the state that the second cap 31b is in the capping state and the rotation member 60 is located at the second cleaning position. With this, the suction is performed inside the second cap 31b covering the second ejection surface 21b, and the negative pressure is generated in the space surrounded by the second ejection surface 21b and the second cap 31b.

Therefore, the cleaning liquid flows from the cleaning liquid tank 34 through the second cleaning liquid upstream port 52b, the cleaning liquid path 75, and the second cleaning liquid downstream port 53b in this order, and then flows into the second cap 31b. The cleaning liquid then flows from the second cap 31b through the second waste liquid port 55b, the third waste liquid path 76c, and the intake port 54 in this order, and is exhausted into the waste liquid tank 35. This second preliminary cleaning process causes the cleaning liquid to adhere to the inside of the second cap 31b and the inside of the waste liquid channel which includes the second waste liquid port 55b, the third waste liquid path 76c and the intake port 54. By causing the cleaning liquid to preliminary adhere to the inside of the second cap 31b and the inside of the waste liquid channel, the cleaning liquid is dispersed in the inside of the second cap 31b and the inside of the waste liquid channel; in a case where the second liquid contacts the cleaning liquid, the second liquid is diluted by the cleaning liquid. In a case that the second liquid is diluted, the second liquid thus becomes less likely to solidify, thereby making the second liquid less likely to solidify in the second cap 31b and the waste liquid channel.

Therefore, even in a case where the second liquid is sucked into the second cap 31b by the second purge process (step S14) executed after the second preliminary cleaning process has been executed, the second liquid is not firmly fixed to the inside of the second cap 31b and the inside of the waste liquid channel, and is easily exhausted from the second cap 31b through the waste liquid channel. Note that the second liquid may be exhausted from the second cap 31b, without being accumulated up to the second ejection surface 21b in the second cap 31b. This shortens the time required for the second preliminary cleaning process.

### Second Modification

In a liquid ejecting apparatus 10 according to a second modification, the suction pump 36 performs the suction with a first suction force or a second suction force which is greater than the first suction force. For example, as depicted in FIG. 2, the suction pump 36 has a pump motor 36a. The suction force of the suction pump 36 can be increased by increasing the rotation amount of the pump motor 36a. The rotation amount of the pump motor 36a is controlled by the controller 40. The controller 40 drives the suction pump 36 to perform the suction with the first suction force, by driving the pump motor 36a at a first rotation amount. Further, the controller 40 drives the suction pump 36 to perform the suction with the second suction force which is greater than the first suction force, by driving the pump motor 36a at a second rotation amount which is greater than the first rotation amount.

In a case where the controller 40 executes the first preliminary cleaning process in step S20 in the flowchart of the example (second modification) of FIG. 13, the controller 40 drives the suction pump 36 to perform the suction with the first suction force, by driving the pump motor 36a at the first rotation amount. This causes the cleaning liquid to flow from the cleaning liquid tank 34 into the first cap 31a, to clean the first cap 31a, and then to be exhausted to the waste liquid tank 35. This cleaning liquid does not contain a solid component and has a lower viscosity than the viscosity of the first liquid which contains the solid component. Therefore, the first cap 31a can be cleaned by causing the cleaning liquid to flow by the suction of the suction pump 36 with the first suction force which is small, while reducing the electrical power consumption by driving the pump motor 36a at the first rotation amount which is small.

Further, in a case where the controller 40 executes the first purge process in step S10 after step S20, the controller 40 drives the pump motor 36a at the second rotation amount and causes the suction pump 36 to perform the suction with the second suction force. The first liquid contains the solid component, and this solid component contains the resin fine particles and the solid component of the colorant. For example, the first liquid contains the resin fine particles at a content amount in the range of 0.1 wt % to 30 wt %, and the solid component of the colorant at a content amount in the range of 0.1 wt % to 20 wt %. The viscosity of this first liquid is higher than the viscosity of the cleaning liquid. Even in such a case, by causing the suction pump 36a to perform the suction with the second suction force which is great, the first liquid can be sucked from the first nozzles 23a and into the first cap 31a, and can be exhausted from the first cap 31a to the waste liquid tank 35.

Furthermore, in a case where the controller 40 executes the second preliminary cleaning process in step S21, the controller 40 drives the suction pump 36 to perform the suction with the first suction force, by driving the pump motor 36a at the first rotation amount. As a result, the cleaning liquid flows from the cleaning liquid tank 34 into the second cap 31b, cleans the second cap 31b, and then is exhausted to the waste liquid tank 35. This cleaning liquid does not contain the solid component and has the lower viscosity than the viscosity of the second liquid which contains the solid component. Therefore, the second cap 31b can be cleaned by causing the cleaning liquid to flow by the suction of the suction pump 36 with the first suction force which is small, while reducing the electrical power consumption by driving the pump motor 36a at the first rotation amount which is small.

Moreover, in a case where the controller 40 executes the second purge process in step S14 after step S21, the controller 40 drives the suction pump 36 to perform the suction with the second suction force, by driving the pump motor 36a at the second rotation amount. The second liquid contains the solid content, and this solid content includes the resin fine particles and the solid content of the colorant. For example, the second liquid contains the resin fine particles at a content amount in the range of 0.1 wt % to 30 wt %, and contains the solid content of the colorant at a content amount in the range of 0.1 wt % to 20 wt %. The viscosity of this second liquid is higher than the viscosity of the cleaning liquid. Even in such a case, by causing the suction pump 36a to perform the suction with the second suction force which is great, the second liquid can be sucked from the second nozzles 23b and into the second cap 31b, and can be exhausted from the second cap 31b to the waste liquid tank 35.

### Other Modifications

In the above-described embodiment and the first modification, the first to fourth waste liquid paths 76a to 76d are open to the atmosphere via the intake port 54 in the first pressure-boosting process, and the first to fourth waste liquid paths 76a to 76d are open to the atmosphere via the atmosphere port 56 in the second pressure-boosting process. However, the method of opening the first to fourth waste liquid paths 76a to 76d to the atmosphere in the first pressure-boosting process and the second pressure-boosting process is not limited to this. For example, in the first pressure-boosting process, the first to fourth waste liquid paths 76a to 76d may be open to the atmosphere via the atmosphere port 56, and in the second pressure-boosting process, the first to fourth waste liquid paths 76a to 76d may be open to the atmosphere via the intake port 54. Alternatively, in both the first pressure-boosting process and the second pressure-boosting process, the first to fourth waste liquid paths 76a to 76d may be open to the atmosphere via the intake port 54, or the first to fourth waste liquid paths 76a to 76d may be open to the atmosphere via the atmosphere port 56.

In the above-described embodiment and the modifications, an open/close valve 33d (see FIG. 3) which is configured to open and close the exhaust path 33a may be disposed in the exhaust body 33b. In this case, a cam 61a (see FIG. 4) which is configured to open and close the open/close valve 33d may be disposed in the gear part 61 of the rotation member 60. In a case where the cam 61a rotates due to the rotation of the rotation member 60 to thereby close the open/close valve 33d, the exhaust path 33a is shut off (blocked). This prevents the air from entering the buffer tank 13 and the liquid ejecting head 20 via the exhaust path 33a.

On the other hand, in a case where the cam 61a rotates by the rotation of the rotation member 60 to thereby open the open/close valve 33d, the exhaust path 33a is released. With this, in the capping state that the exhaust surface 33b1 in which the exhaust path 33a is open is covered by the exhaust cap 33c, the buffer tank 13 and the exhaust cap 33c communicate with each other via the exhaust path 33a. Since the exhaust cap 33c communicates with the tube 39a in which the suction pump 36 is disposed, the controller 40 executes the exhaust-purge process by driving the suction pump 36. This exhaust-purge process can reduce the unnecessary exhaust of the liquid while shortening the processing time, as compared to the method of discharging the air bubble by the suction of the liquid. Further, since the cam 61a is disposed in the rotation member 60, the communication state among the first cleaning liquid upstream port 52a, the second cleaning liquid upstream port 52b, the first cleaning liquid downstream port 53a, the second cleaning liquid downstream port 53b, the first waste liquid port 55a, the second waste liquid port 55b, the atmosphere port 56, the exhaust port 57, and the cleaning liquid path 75 and the first to fourth waste liquid paths 76a to 76d can be changed, and the open/close valve 33d can be opened and closed.

What is claimed is:

1. A liquid ejecting apparatus, comprising:
a liquid ejecting head having an ejection surface with nozzles opening therein;
a cap configured to cover the ejection surface;
a suction pump;
a cleaning liquid tank configured to store cleaning liquid; and
a switching valve having a fixed member, a rotation member, and a channel member,
wherein the fixed member has:
a main body configured to support the channel member;
a cleaning liquid upstream port being a hollow protrusion protruding from the main body and connected to the cleaning liquid tank via a tube;
a cleaning liquid downstream port and a waste liquid port each being a hollow protrusion protruding from the main body and connected to the cap via a tube; and
an intake port being a hollow protrusion protruding from the main body and connected to a tube having the suction pump disposed therein,
the rotation member is configured to rotate with respect to the fixed member, and has a first cleaning liquid path, and
the channel member is attached to the rotation member and configured to rotate together with the rotation member with respect to the fixed member, the channel member having:
a second cleaning liquid path connected to the first cleaning liquid path to form a cleaning liquid path communicating the cleaning liquid upstream port and the cleaning liquid downstream port with each other; and
a waste liquid path communicating the waste liquid port and the intake port with each other.

2. The liquid ejecting apparatus according to claim 1, wherein
the nozzles include a first nozzle configured to eject first liquid and a second nozzle configured to eject second liquid,
the ejection surface includes a first ejection surface and a second ejection surface,
the cap includes a first cap configured to cover the first ejection surface and a second cap configured to cover the second ejection surface,
the cleaning liquid upstream port includes a first cleaning liquid upstream port and a second cleaning liquid upstream port each communicating with the cleaning liquid tank,
the cleaning liquid downstream port includes a first cleaning liquid downstream port communicating with the first cap and a second cleaning liquid downstream port communicating with the second cap, and
the waste liquid port includes a first waste liquid port communicating with the first cap and a second waste liquid port communicating with the second cap.

3. The liquid ejecting apparatus according to claim 2, wherein when the rotation member is located at a first cleaning position, the waste liquid path communicates with the first waste liquid port and the intake port and the cleaning liquid path communicates with the first cleaning liquid upstream port and the first cleaning liquid downstream port.

4. The liquid ejecting apparatus according to claim 2, wherein when the rotation member is located at a first purge position, the waste liquid path communicates with the first waste liquid port and the intake port and the cleaning liquid path does not communicate with the first cleaning liquid upstream port and the first cleaning liquid downstream port.

5. The liquid ejecting apparatus according to claim 2, wherein a size of the waste liquid path in a direction orthogonal to a radial direction of the channel member is equal to or greater than a total size of a size of the first waste liquid port in a direction orthogonal to a radial direction of the fixed member and a size of the first cleaning liquid downstream port in the direction orthogonal to the radial direction of the fixed member.

6. The liquid ejecting apparatus according to claim 2, wherein the when rotation member is located at a second cleaning position, the waste liquid path communicates with the second waste liquid port and the intake port and the cleaning liquid path communicates with the second cleaning liquid upstream port and the second cleaning liquid downstream port.

7. The liquid ejecting apparatus according to claim 2, wherein when the rotation member is located at a second purge position, the waste liquid path communicates with the second waste liquid port and the intake port and the cleaning liquid path does not communicate with the second cleaning liquid upstream port and the second cleaning liquid downstream port.

8. The liquid ejecting apparatus according to claim 2, wherein a size of the waste liquid path in a direction orthogonal to a radial direction of the channel member is equal to or greater than a total size of a size of the second waste liquid port in a direction orthogonal to a radial direction of the fixed member and a size of the second cleaning liquid downstream port in the direction orthogonal to the radial direction of the fixed member.

9. The liquid ejecting apparatus according to claim 3, further comprising:
a rotation device configured to rotate the rotation member with respect to the fixed member; and
a controller,
wherein the controller is configured to drive the suction pump, in a state that the rotation member is located at the first cleaning position, to execute a first cleaning process of cleaning the first ejection surface covered by the first cap.

10. The liquid ejecting apparatus according to claim 9, wherein the controller is configured to drive the suction pump, before the controller executes the first cleaning process and in a state that the rotation member is located at a first purge position, the waste liquid path communicating with the first waste liquid port and the intake port at the first purge position, and the cleaning liquid path not communicating with the first cleaning liquid upstream port and the first cleaning liquid downstream port at the first purge position, to execute a first purge process of performing suction inside the first cap covering the first ejection surface, and
the controller is configured to drive the suction pump, before the controller executes the first purge process and in a state that the rotation member is located at the first cleaning position, to execute a first preliminary cleaning process of causing the cleaning liquid to adhere to the first cap covering the first ejection surface.

11. The liquid ejecting apparatus according to claim 9, wherein the first liquid contains a solid content,
the solid content includes resin fine particles and a solid content of a colorant,
the resin fine particles are contained in the first liquid in a range of 0.1 wt % to 30 wt % inclusive,
the solid content of the colorant is contained in the first liquid in a range of 0.1 wt % to 20 wt % inclusive,
the cleaning liquid does not contain the solid content,
the suction pump is configured to be driven by a first suction force or a second suction force greater than the first suction force,
the controller is configured to drive the suction pump, before the controller executes the first cleaning process and in a state that the rotation member is located at a first purge position, the waste liquid path communicating with the first waste liquid port and the intake port at the first purge position, and the cleaning liquid path not communicating with the first cleaning liquid upstream port and the first cleaning liquid downstream port at the first purge position, to execute a first purge process of performing suction inside the first cap covering the first ejection surface,
the controller is configured to drive the suction pump, before the controller executes the first purge process and in a state that the rotation member is located at the first cleaning position, to execute a first preliminary cleaning process of cleaning the first cap covering the first ejection surface, and
the suction pump is configured to be driven by the first suction force in a case where the controller executes the first preliminary cleaning process, and the suction pump is configured to be driven by the second suction force in a case where the controller executes the first purge process.

12. The liquid ejecting apparatus according to claim 6, further comprising:
a rotation device configured to rotate the rotation member with respect to the fixed member; and
a controller,
wherein the controller is configured to drive the suction pump, in a state that the rotation member is located at the second cleaning position, to execute a second cleaning process of cleaning the second ejection surface covered by the second cap.

13. The liquid ejecting apparatus according to claim 12, wherein the controller is configured to drive the suction pump, before the controller executes the second cleaning process and in a state that the rotation member is located at a second purge position, the waste liquid path communicating with the second waste liquid port and the intake port at the second purge position, and the cleaning liquid path not communicating with the second cleaning liquid upstream port and the second cleaning liquid downstream port at the second purge position, to execute a second purge process of performing suction inside the second cap covering the second ejection surface, and
the controller is configured to drive the suction pump, before the controller executes the second purge process and in a state that the rotation member is located at the second cleaning position, to execute a second preliminary cleaning process of causing the cleaning liquid to adhere to the second cap covering the second ejection surface.

14. The liquid ejecting apparatus according to claim 12, wherein the second liquid contains a solid content,
the solid content includes resin fine particles and a solid content of a colorant,
the resin fine particles are contained in the second liquid in a range of 0.1 wt % to 30 wt % inclusive,
the solid content of the colorant is contained in the second liquid in a range of 0.1 wt % to 20 wt % inclusive,
the cleaning liquid does not contain the solid content,
the suction pump is configured to be driven by a first suction force or a second suction force greater than the first suction force,
the controller is configured to drive the suction pump, before the controller executes the second cleaning process and in a state that the rotation member is located at a second purge position, the waste liquid path communicating with the second waste liquid port and the intake port at the second purge position, and the cleaning liquid path not communicating with the second cleaning liquid upstream port and the second cleaning liquid downstream port at the second purge position, to execute a second purge process of performing suction inside the second cap covering the second ejection surface,
the controller is configured to drive the suction pump, before the controller executes the second purge process and in a state that the rotation member is located at the second cleaning position, to execute a second preliminary cleaning process of causing the cleaning liquid to adhere to the inside of the second cap covering the second ejection surface, and
the suction pump is configured to be driven by the first suction force in a case where the controller executes the second preliminary cleaning process, and the suction pump is configured to be driven by the second suction force in a case where the controller executes the second purge process.

15. A control method of a liquid ejecting apparatus, the liquid ejecting apparatus including:
a liquid ejecting head having an ejection surface with nozzles opening therein;
a cap configured to cover the ejection surface;
a suction pump;
a cleaning liquid tank configured to store cleaning liquid; and
a switching valve having a fixed member, a rotation member, and a channel member,
the fixed member having:
a main body configured to support the channel member; and
ports including a cleaning liquid upstream port being a hollow protrusion protruding from the main body and connected to the cleaning liquid tank via a tube, a cleaning liquid downstream port and a waste liquid port each being a hollow protrusion protruding from the main body and connected to the cap via a tube, and an intake port being a hollow protrusion protruding from the main body and connected to a tube having the suction pump disposed therein,
the rotation member being configured to rotate with respect to the fixed member, and having a first cleaning liquid path,
the channel member being attached to the rotation member and configured to rotate together with the rotation member with respect to the fixed member,
the channel member having:
a second cleaning liquid path connected to the first cleaning liquid path to form a cleaning liquid path communicating the cleaning liquid upstream port and the cleaning liquid downstream port with each other; and
a waste liquid path communicating the waste liquid port and the intake port with each other,
the control method comprising changing a communication state between the ports and the cleaning liquid path and between the ports and the waste liquid path by rotation of the rotation member.

16. A non-transitory medium storing a control program for a liquid ejecting apparatus, the liquid ejecting apparatus including:
a liquid ejecting head having an ejection surface with nozzles opening therein;
a cap configured to cover the ejection surface;
a suction pump;
a cleaning liquid tank configured to store cleaning liquid;
a switching valve having a fixed member, a rotation member, and a channel member; and
a controller,
the fixed member having:
a main body configured to support the channel member; and
ports including: a cleaning liquid upstream port being a hollow protrusion protruding from the main body and connected to the cleaning liquid tank via a tube; a cleaning liquid downstream port and a waste liquid port each being a hollow protrusion protruding from the main body and connected to the cap via a tube; and an intake port being a hollow protrusion protruding from the main body and connected to a tube having the suction pump disposed therein,
the rotation member being configured to rotate with respect to the fixed member, and having a first cleaning liquid path, and
the channel member being attached to the rotation member and configured to rotate together with the rotation member with respect to the fixed member,
the channel member having:
a second cleaning liquid path connected to the first cleaning liquid path to form a cleaning liquid path communicating the cleaning liquid upstream port and the cleaning liquid downstream port with each other; and
a waste liquid path communicating the waste liquid port and the intake port,
the control program causing the controller to change a communication state between the ports and the cleaning liquid path and between the ports and the waste liquid path by rotation of the rotation member.
